(19) United States
(12) Patent Application Publication
(10) Pub. No.: US 2026/0289184 A1
(43) Pub. Date: Sep. 24, 2026

(54) SYSTEM

(71) Applicant: SoftBank Group Corp., Tokyo (JP)

(72) Inventor: Masafumi MIZUNO, Tokyo (JP)

(73) Assignee: SoftBank Group Corp., Tokyo (JP)

(21) Appl. No.: 19/568,924

(22) Filed: Mar. 17, 2026

(30) Foreign Application Priority Data
Mar. 19, 2025 (JP) 2025-045090

(51) Int. Cl. G06F 40/40; G06F 40/205; G06F 40/30; G10L 25/63

(52) U.S. Cl. CPC G06F 40/40; G06F 40/205; G06F 40/30; G10L 25/63

(57) ABSTRACT

A system includes a processor that is configured to receive information via an interface for receiving information from a user, generate a prompt sentence that instructs a generative AI model to identify a relevant service by using the generative AI model to analyze the received information, input the generated prompt sentence into the generative AI model, obtain an analysis result from the generative AI model, and sort the information into an appropriate service based on the analysis result, and analyze voice data of the user to evaluate an emotional state of the user and adjust a priority of the information based on an evaluation result of the emotional state.

### CROSS-REFERENCE TO RELATED APPLICATION

This application is based on and claims priority under 35 USC 119 from Japanese Patent Application No. 2025-045090 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information sorting and routing systems in customer service environments typically rely on fixed rule-based logic or simple keyword matching to associate user inputs with corresponding services. Such systems are often unable to flexibly interpret free-form natural language inputs, mixed text and voice inputs, or complex multi-intent queries from users. As a result, the classification of user information into appropriate services may be inaccurate or incomplete, leading to inefficient handling of user requests and reduced quality of service.

Furthermore, traditional systems generally do not consider the emotional state of the user when prioritizing or routing information. In customer support or consultation scenarios, the emotional state of the user, such as frustration, anxiety, or urgency, can be a critical factor in determining how quickly or in what order the user's issues should be addressed. However, existing systems usually treat all user information with equal priority, regardless of the emotional context reflected in the user's voice data. This can cause delays in responding to emotionally urgent cases and may degrade the overall user experience.

In addition, while generative AI models and natural language processing technologies have advanced, many current systems do not effectively utilize these technologies to generate prompts and to perform deep contextual analysis for mapping user information to relevant services. Without an integrated mechanism for generating appropriate prompts for a generative AI model and combining that analysis with emotion-based prioritization, it is difficult to achieve both accurate service classification and dynamic priority control tailored to the user's emotional state.

Accordingly, there is a need for a system that can: (i) receive information from a user through an interface, (ii) generate and provide suitable prompts to a generative AI model to accurately identify relevant services from the content of the user's information, and (iii) evaluate the user's emotional state from voice data and adjust the priority of the information based on this evaluation, thereby improving the accuracy and responsiveness of information sorting and service routing.

### SUMMARY

In order to solve the above-described problems, an aspect of the present invention provides a system comprising a processor, wherein the processor is configured to receive information via an interface for receiving information from a user, generate a prompt sentence that instructs a generative AI model to identify a relevant service by using the generative AI model to analyze the received information, input the generated prompt sentence into the generative AI model, obtain an analysis result from the generative AI model, and sort the information into an appropriate service based on the analysis result, and analyze voice data of the user to evaluate an emotional state of the user and adjust a priority of the information based on an evaluation result of the emotional state.

According to one embodiment, the processor is configured to generate the prompt sentence by using natural language processing technology to automatically determine the relevant service from content of the received information and perform the analysis by inputting the prompt sentence into the generative AI model. In this way, the system can flexibly interpret natural language inputs and construct context-appropriate prompt sentences that enable the generative AI model to accurately identify services correlated with the user's request or inquiry.

According to another embodiment, the processor is configured to execute a priority setting algorithm that evaluates the emotional state of the user and preferentially sorts the information based on the evaluation result. The processor analyzes the user's voice data to detect emotional indicators such as stress, urgency, or dissatisfaction, and adjusts the priority level assigned to each piece of information so that information associated with a higher-emotion or higher-urgency state is processed earlier or routed with higher priority.

Through the combination of generative AI-based analysis of user information and emotion-aware priority control, the system can classify user information into appropriate services with improved accuracy while dynamically prioritizing handling according to the user's emotional state. This integrated approach enables more responsive and user-centric information routing and supports higher-quality customer service and operational efficiency.

The term “system” refers to an arrangement of one or more hardware and/or software components that cooperate to perform the functions described in the present specification and claims, including at least a processor and associated memory and interfaces.

The term “processor” refers to any hardware component or combination of components configured to execute instructions, including but not limited to a central processing unit (CPU), a graphics processing unit (GPU), a digital signal processor (DSP), an application-specific integrated circuit (ASIC), a field programmable gate array (FPGA), or a combination thereof.

The term “interface” refers to any hardware and/or software component that enables the exchange of information between the system and a user or between the system and another device, including but not limited to graphical user interfaces, application programming interfaces (APIs), network interfaces, and input/output devices.

The term “user” refers to any human operator or entity that provides information to the system, receives output from the system, or otherwise interacts with the system, including customers, operators, agents, or administrators.

The term “information” refers to any data received from the user via the interface, including but not limited to text data, voice data, image data, metadata, and structured or unstructured digital content.

The term “prompt sentence” refers to a text string or data structure generated by the processor that is provided as input to a generative AI model and that instructs or conditions the generative AI model to perform a particular analysis, such as identifying a relevant service for the received information.

The term “generative AI model” refers to any machine learning model configured to generate or transform content based on input data, including but not limited to large language models, transformer-based models, generative adversarial networks (GANs), or other neural network architectures capable of analyzing and generating natural language or other data formats.

The term “analysis result” refers to any output produced by the generative AI model in response to the prompt sentence, including but not limited to classifications, labels, recommendations, extracted entities, or other structured or unstructured data indicating a relationship between the received information and one or more services.

The term “service” refers to any function, product, support operation, or processing task that can be provided or performed by a business, system, or platform in response to user information, including but not limited to customer support services, subscription services, informational services, and automated processing services.

The term “sort the information into an appropriate service” refers to associating, routing, classifying, or mapping the received information to one or more services determined to be relevant based on the analysis result of the generative AI model.

The term “voice data” refers to any audio signal or digital representation of speech produced by the user, including raw audio waveforms, encoded audio streams, or derived acoustic features.

The term “emotional state” refers to a state or condition of the user's affect or emotion, such as calmness, stress, frustration, satisfaction, urgency, or other affective conditions, as inferred from the user's voice data or other characteristics.

The term “evaluate an emotional state” refers to processing and analyzing the user's voice data or related features to estimate, classify, or infer one or more emotional conditions or levels associated with the user.

The term “priority of the information” refers to a relative level or order of importance, urgency, or processing preference assigned to the received information for subsequent handling, routing, or response.

The term “adjust a priority of the information” refers to modifying, increasing, decreasing, or reordering the priority assigned to the information based on one or more factors, including the evaluation result of the user's emotional state.

The term “natural language processing technology” refers to any algorithm, model, or technique for processing human language data, including but not limited to tokenization, parsing, named entity recognition, intent detection, semantic analysis, and generation of natural language text.

The term “priority setting algorithm” refers to a set of rules, models, or computational procedures executed by the processor to determine or modify the priority of information based on one or more inputs, including at least an evaluation result of the emotional state of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

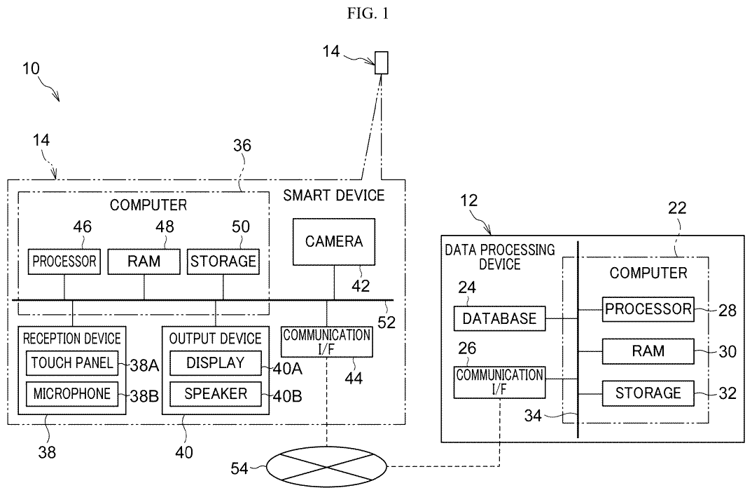

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

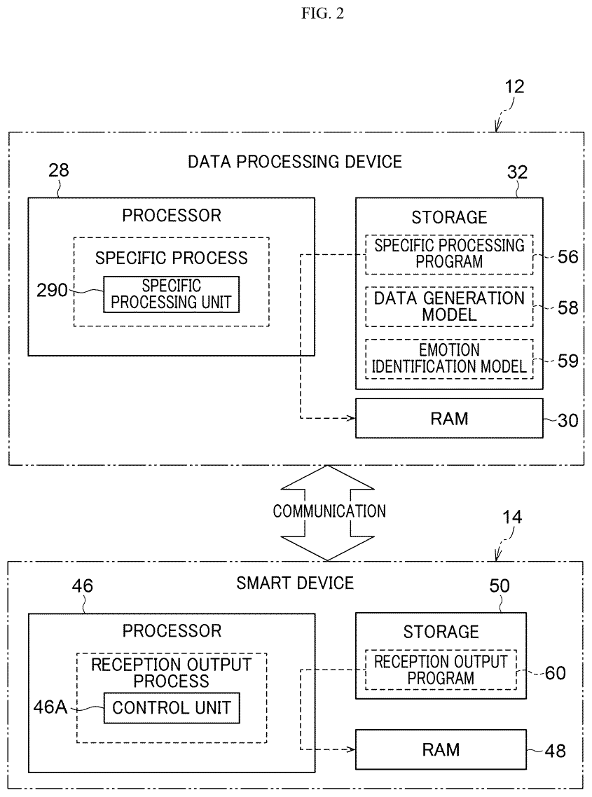

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional service management systems that allow a user to check usage status and available services from a terminal suffer from multiple technical limitations. A typical architecture uses a fixed set of application rules on a server to interpret user identification data, query a data store, and return a static list of subscribed and unsubscribed services. Such systems are rigid and cannot flexibly adapt the content or prioritization of service information to different user contexts or changing service offerings. As a result, the server often performs inefficient data retrieval and classification operations, and the terminal cannot provide responsive, context-aware guidance to the user.

In many existing systems, a server simply performs direct database lookups keyed by an identification number and date of birth, and returns raw results to a terminal. The server does not leverage advanced language processing to interpret higher-level relationships between user information and service information, nor does it dynamically generate query logic or classification logic. This leads to excessive reliance on manually designed decision rules, which increases maintenance costs, reduces scalability, and can cause unnecessary database load due to non-optimized queries.

Moreover, conventional systems usually treat all users identically in terms of how unsubscribed services are ordered and presented. A server may return a generic, unprioritized list of services, and a terminal may merely display this list in a fixed order. Such behavior fails to consider the user's emotional state or engagement level, and therefore may reduce the effectiveness of the user interface and the likelihood of successful service selection. From the perspective of computer technology, the absence of an integrated mechanism for capturing user emotion and using that signal to drive information prioritization results in a suboptimal allocation of processing resources and screen real estate.

Additionally, current systems rarely exploit generative models to automatically construct refined query sentences or decision prompts based on the user's identification information and retrieved usage state. Instead, servers rely on static query templates. This limits the system's ability to infer nuanced additional service information or contextual recommendations without extensive manual rule coding. As a consequence, the server cannot efficiently adapt to large and heterogeneous service catalogs, and accurate classification or prioritization of information requires labor-intensive engineering.

There is therefore a need for an improved computer-implemented system in which a processor cooperates with a terminal, a storage device, a communication mechanism, a generative processing model, and a natural language processing module to: (i) automatically generate query sentences and prompt sentences for the generative model from received user-related information; (ii) derive additional service information related to unsubscribed services using the generative model; (iii) convert user information and additional service information into a structured data format suitable for efficient transmission and parsing; and (iv) evaluate a user's emotional state from voice information and dynamically adjust the priority, order, and mode of presentation of service information. Such a system improves the efficiency and adaptability of information retrieval and classification in the server, optimizes communication between the server and the terminal, and enhances the technical performance of the overall human-computer interaction flow.

The specific processing by the specific processing unit 290 of the data processing device 12 in Example 1 is realized by the following means.

The present invention provides a server comprising a processor configured to receive identification information and authentication information transmitted from a terminal via a communication mechanism, collate an information set stored in a storage device based on the identification information and the authentication information so as to extract user information including usage state information and unsubscribed service information, generate a query sentence based on the extracted user information in order to automatically specify the unsubscribed service information, input the query sentence to a generative processing model so as to obtain additional service information related to the unsubscribed service information, use natural language processing technology to generate a prompt sentence to be input to the generative processing model, the prompt sentence being automatically generated from contents of the received information so as to generate the query sentence, convert the user information and the additional service information into a structured data format and transmit the structured data format to the terminal via an encrypted communication mechanism, and analyze voice information of a user at the terminal or at the server so as to evaluate an emotional state of the user and adjust a display order or a notification order of the unsubscribed service information and the additional service information based on the emotional state. This enables the server to dynamically construct and execute optimized data retrieval and classification processes, to reduce reliance on static rule sets, to efficiently generate context-aware additional service information via the generative processing model, to transmit machine-parsable structured data to the terminal for rapid rendering, and to improve overall system responsiveness and user interface effectiveness by automatically prioritizing and presenting service information in accordance with the evaluated emotional state of the user.

The term “system” refers to an arrangement of one or more electronic devices, storage resources, and software components that cooperate to execute information processing, communication, and presentation functions as described herein.

The term “processor” refers to a hardware computation element, such as a central processing unit or a processing core, that executes machine-readable instructions to perform logical operations, arithmetic operations, control operations, and data transfer operations.

The term “terminal” refers to an electronic apparatus, such as a user-facing computing device, that includes an input and output device and is configured to transmit and receive information to and from a server via a communication mechanism.

The term “input and output device” refers to a hardware interface, such as a display with a touch panel, a keyboard, a pointing device, a speaker, or a microphone, that enables a user to input information to the terminal and to receive information from the terminal.

The term “server” refers to an electronic apparatus, typically connected to a communication network, that includes a processor and a storage device and is configured to execute information processing services in response to requests from one or more terminals.

The term “identification information” refers to data that uniquely or quasi-uniquely identifies a user or an account, such as an identification code, a membership number, or other user-specific identifier.

The term “authentication information” refers to data used to verify the identity of a user or an account, such as a date of birth, a password, a personal identification number, or other credential information.

The term “communication mechanism” refers to any combination of hardware, software, and protocols that enables transmission and reception of data between the terminal and the server, including wired or wireless networks and associated communication protocols.

The term “encrypted communication mechanism” refers to a communication mechanism in which data transmitted between the terminal and the server is transformed into an encrypted form using cryptographic techniques so as to protect the data against unauthorized access or tampering.

The term “storage device” refers to a hardware component, such as a semiconductor memory, magnetic storage, or optical storage, that stores an information set including user information, service information, and other related data.

The term “information set” refers to a logical collection of related data elements stored in the storage device, such as records of users, service subscriptions, and available services.

The term “user information” refers to data associated with a particular user, including identification information, authentication information, usage state information, unsubscribed service information, and other related attributes.

The term “usage state information” refers to data indicating how a user utilizes one or more services, including current subscription status, active periods, usage history, or other indicators of service usage.

The term “unsubscribed service information” refers to data indicating services that are available in a service catalog but are not currently subscribed to by the user identified by the identification information and the authentication information.

The term “additional service information” refers to data derived by processing, including generative processing, that relates to one or more unsubscribed services and may include recommended services, related options, or contextual information about those services.

The term “query sentence” refers to a textual or structured expression generated by the processor that describes, in a form interpretable by a generative processing model or an information management mechanism, a request for information regarding services or user states.

The term “prompt sentence” refers to a textual instruction or input expression that is generated using natural language processing technology and is supplied to the generative processing model to induce the model to produce a generation result relevant to the received information.

The term “generative processing model” refers to a computer-implemented model, such as a generative artificial intelligence model, that receives a prompt sentence or query sentence as input and generates corresponding output data, such as additional service information or classification results.

The term “natural language processing technology” refers to a set of computational techniques that analyze, interpret, generate, or manipulate human language data so as to convert input information into one or more prompt sentences or query sentences.

The term “structured data format” refers to a data representation having a defined structure, such as a key-value hierarchy or a tabular arrangement, that facilitates programmatic parsing, interpretation, and processing by the terminal or the server.

The term “collate” refers to the operation of comparing or associating received identification information and authentication information with corresponding data contained in the information set stored in the storage device so as to locate and extract relevant user information.

The term “classify” refers to the operation of assigning information to one or more categories or groups, such as mapping data items to a particular service, service status, or priority level, based on predetermined criteria or generated results.

The term “analyze” refers to the operation of processing data using logical rules, statistical methods, signal processing, or model-based inference in order to extract features, evaluate conditions, or derive a result.

The term “voice information” refers to audio data representing speech or other vocal sounds produced by a user and acquired by an input and output device, and may include raw waveforms or processed acoustic features.

The term “emotional state” refers to a condition of user affect, such as satisfaction, frustration, interest, or disinterest, inferred by analyzing the voice information or other user-related data.

The term “emotion index” refers to a numerical or symbolic value computed from features of the voice information that quantitatively expresses the emotional state of the user.

The term “display order” refers to an arrangement sequence in which multiple pieces of information, such as unsubscribed service information and additional service information, are presented on a display device.

The term “notification order” refers to a temporal or priority sequence in which alerts, messages, or prompts relating to unsubscribed service information or additional service information are provided to the user.

The term “presentation mode” refers to a manner of presenting information to the user, including layout, emphasis, highlighting, or interaction style, determined in accordance with priority or emotional state.

The term “information management mechanism” refers to a logical or physical component, such as a database management system or an information retrieval engine, that manages the storage, indexing, and retrieval of the information set in the storage device.

The term “inquiry processing instruction” refers to a command or request generated by the processor for the information management mechanism to perform a search or retrieval operation based on specified conditions.

The term “data conversion processing” refers to an operation that transforms data from one representation, such as internal objects or database records, into another representation, such as a structured data format suitable for transmission or display.

The term “priority setting processing” refers to an operation in which the processor assigns priority values or ranks to items of unsubscribed service information or additional service information based on the emotion index or other criteria.

In one embodiment, a server cooperates with a terminal and a storage device to implement the system. The server includes at least one processor, a memory, a network interface controller, and a non-transitory storage device. The terminal includes an input and output device such as a touch-sensitive display, a microphone, a speaker, and optionally a hardware keyboard. The user operates the terminal to provide identification information and authentication information, and to view and confirm service information.

The server executes an operating system such as a generic server operating system, and runs application software including a web server component (for example, an HTTP server), an application logic component, a database client library, a natural language processing module, and a generative AI model execution engine. The server accesses a database management system such as a relational database engine to manage an information set including user records, subscription records, and service catalog records stored on a storage device such as a magnetic disk drive or a solid-state drive.

The terminal executes an operating system such as a mobile or desktop operating system and runs a client application or a web browser. The terminal uses a graphical user interface library to render input fields and result views. The terminal also uses an audio stack to capture voice information from the user through the microphone and to transmit the captured audio data to the server in a digital format, such as a sequence of sampled waveform values or compressed audio frames.

The server receives identification information and authentication information transmitted from the terminal via a communication mechanism such as a secure transport protocol. The server uses a transport layer security library to decrypt the received packets and reconstruct the message payload. The server parses the payload into a data structure in memory, for example, an object that contains fields for an identification string and a date value. The server then uses these fields as indexes or search keys to collate an information set stored in the storage device. The server sends query instructions to the database management system and causes the database management system to execute search operations using the identification information and the authentication information as conditions.

The server retrieves user information from the database management system, including usage state information and unsubscribed service information. The server typically obtains at least one record that represents the current contract period and one or more records that represent services already subscribed to by the user. The server also obtains a list of all services defined in a service catalog table. The server compares identifiers of subscribed services with identifiers of catalog services using set operations performed in memory. The server produces unsubscribed service information as the difference between the full service set and the subscribed service set. This comparison uses specific data structures, such as arrays or hash sets of service identifiers, and is executed as deterministic operations in the processor. By performing these set operations in memory, the server reduces the number of complex database joins and thereby improves processing speed and reduces load on the database engine.

The server generates a query sentence based on the extracted user information. The server constructs the query sentence as a natural language string or as a structured textual description that includes, for example, user profile attributes, a summary of current subscription status, and a list or description of unsubscribed service categories. The server uses a natural language processing module to map internal data structures into tokens and phrases. The server may apply predefined templates combined with dynamic insertion of slot values, but the templates are parameterized according to the structure of the information set and the service catalog, rather than being fixed business rules. As a result, the server can adapt the query sentence to new service types without rewriting rule code.

The server inputs the generated query sentence as a prompt sentence to a generative AI model. The server deploys the generative AI model as a trained neural network, for example, a transformer-type sequence model with multiple attention layers. The generative AI model resides in the server memory and executes on the server processor or on a dedicated accelerator. The model has parameters that have been learned from training data that includes historical user-service interactions and textual descriptions of services. The model input consists of tokenized representations of the prompt sentence, including tokens that denote user attributes, usage patterns, and unsubscribed service identifiers. The server uses a tokenization algorithm and an embedding layer to map tokens to numeric vectors. The server then propagates the vectors through attention blocks and feedforward layers according to the learned network architecture.

The server uses a loss function such as a cross-entropy error during training to cause the model to learn associations between input tokens and desirable output tokens that describe relevant additional service information or recommendations. During deployment, the server uses inference procedures such as beam search or top-k sampling to generate candidate output sequences that encode additional service information. The server decodes the sequences into text and parses this text back into structured additional service information, for example, a list of service identifiers along with relevance scores or explanatory notes. The server can also constrain the output by comparing candidate service identifiers against the service catalog, rejecting identifiers that do not exist, thus improving accuracy.

The server uses a distinct neural network, such as a recurrent neural network or a convolutional network followed by a fully connected layer, to process voice information from the user. The server converts the voice information into a sequence of acoustic feature vectors, for example by computing Mel-frequency cepstral coefficients or log-mel spectrograms in a preprocessing stage. The server then feeds the feature vectors into the emotion estimation network, which outputs an emotion index. The server computes a loss function such as mean squared error or categorical cross-entropy against labeled emotional states during training. At runtime, the network produces an emotion index that the server uses as an input signal to a priority setting module.

The server executes a priority setting algorithm that assigns numerical priority values to each element of unsubscribed service information and additional service information. The server uses both relevance scores from the generative AI model and the emotion index as inputs. For example, when the emotion index indicates confusion or low engagement, the server increases the priority of a small subset of simpler services and decreases the priority of complex bundled services. The server computes a composite priority score using a weighted function that combines relevance and emotional factors. This composite score determines the display order and notification order of service items. By using this algorithm, the server reduces cognitive load on the user and shortens the time needed to reach a decision, which in turn reduces the number of display refresh operations and network exchanges between the server and the terminal.

The server converts the user information and the additional service information into a structured data format such as a tree or graph-like representation. The server uses a schema that defines fields for user identification, contract data, a list of currently subscribed services, and a list of candidate additional services with associated attributes. The server serializes this structured representation into a message format that can be parsed efficiently by the terminal.

The server may compress the serialized data to reduce the number of bytes transmitted. Because the server consolidates multiple pieces of information into a single structured message, the server reduces the communication round-trips required between the terminal and the server, thereby reducing latency and network traffic.

The server transmits the structured data to the terminal via an encrypted communication mechanism. The server uses a transport layer security handshake to establish session keys and then encrypts message payloads using symmetric encryption. This reduces the risk of eavesdropping or tampering. The server also manages timeouts and retransmissions to ensure that the terminal receives a complete and valid data set for display. By controlling the size and structure of the transmitted data, the server balances precision of information with overall network efficiency.

The terminal receives the structured data and parses it into internal data structures. The terminal uses a parser module implemented in the client application or browser runtime. The terminal maps fields to user interface components, such as lists, tabs, and detail views. The terminal uses layout logic to group subscribed and unsubscribed service information and to apply the display order and presentation mode specified or implied by the priority values. The terminal may use visual indications such as highlighting, sorting, or grouping to emphasize higher-priority services. The terminal thereby renders a screen that reflects not only database content but also dynamic contextual ranking computed by the server.

The user interacts with the rendered interface to confirm or reject proposed services. The user can select additional services, and the terminal transmits these selections back to the server.

The server updates the information set by inserting new subscription records and adjusts subsequent query sentences and prompt sentences accordingly. As the information set evolves, the model input changes, which allows the generative AI model to adapt the additional service information without human reconfiguration of rules. This contributes to an improvement in overall data management, because the system automatically maintains consistency between the recommended information and the current state of the database.

In a concrete example, the user operates a terminal installed in a retail environment and inputs an identification number and a date of birth. The terminal sends these values to the server. The server searches the database and finds that the user has a basic communication service and a voice service but does not have a streaming service. The server constructs a prompt sentence such as: “Given a user who currently subscribes to basic communication and voice plans but does not subscribe to any streaming or premium content services, identify additional services that would be most relevant and easy to understand for the user.” The server inputs this prompt sentence into the generative AI model. The model outputs a textual description recommending, for example, a standard streaming service and a low-cost data add-on, and the server parses this output into structured additional service information. The server then transmits to the terminal a structured message containing the current services, the unsubscribed services, and the recommended additions, along with a priority value that causes the standard streaming service to appear at the top of the list on the terminal screen. In another example, the user speaks into the terminal's microphone while reviewing the service list. The terminal captures voice data and sends it to the server. The server extracts acoustic features from the voice signal and inputs them into the emotion estimation network. The network outputs an emotion index indicating hesitation. The server uses this emotion index to adjust the priority scores of services that require long-term commitments, lowering their position, and to elevate short-term, low-risk options in the display list. The terminal then re-renders the interface in a manner that highlights services most suitable for a hesitant user. This adaptation is performed by the server using computational logic and neural inference that could not be feasibly reproduced by manual human procedures at the same speed or scale.

The server improves computer technology by combining specific data structures, neural network architectures, and priority algorithms. The server reduces the number of database queries by first collating the information set with compact keys and then performing set operations in memory. The server reduces communication overhead by using structured data formats and compressing multiple logical responses into a single message. The server increases computational efficiency by using transformer-based sequence processing for generating additional service information, and by using separate specialized networks for emotion estimation and for content generation. The model training process includes optimization of weights using gradient descent, regularization techniques to prevent overfitting, and data augmentation for both text and audio inputs, such as synonym replacement or time-stretching of speech, enabling robust operation under diverse conditions. Alternative embodiments are possible. The server can deploy different types of generative AI models, such as encoder-decoder architectures, or models with fewer layers to reduce latency. The server can change the way query sentences are formed, for example by using a sequence-to-sequence module that directly maps internal database fields to textual prompts. The server can adjust the weighting function in the priority setting algorithm depending on application requirements, such as emphasizing cost, bandwidth, or user engagement. The terminal can be a handheld device, a kiosk, or a home gateway, and the communication mechanism can be wired, wireless, or a combination thereof. In each case, the server uses structured, algorithmic processes, rather than manual human judgment, to integrate identification information, generative model outputs, emotion indices, and service catalog details in a way that yields improved accuracy, processing speed, and reduced communication load, thereby providing a concrete enhancement to the functioning of the computer-based system itself.

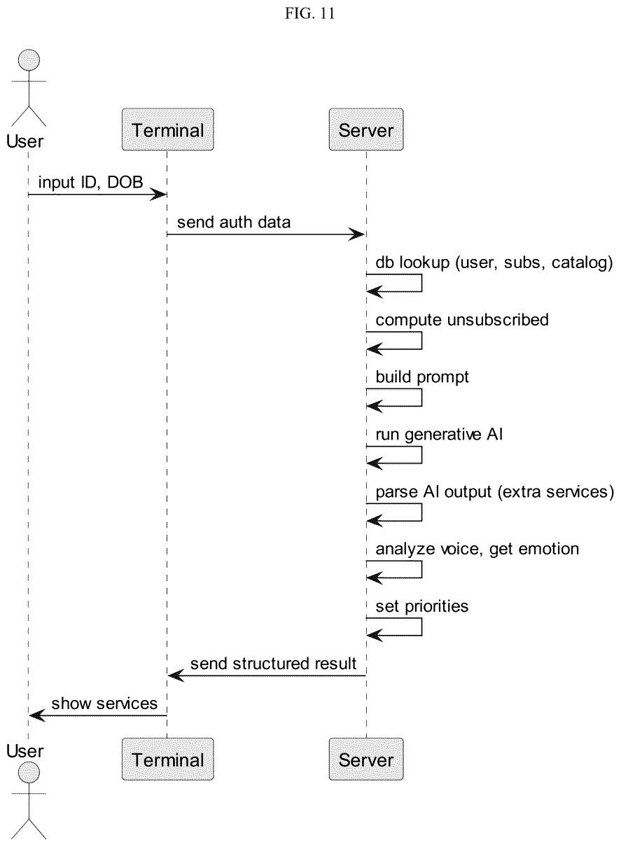

The following describes the processing flow using FIG. 11.

### Step 1

The user operates the terminal to input identification information and authentication information.
The terminal displays input fields on a screen and accepts data via a touch panel or keyboard.
The terminal takes, as input, raw key events or touch coordinates, converts them into character strings, and outputs formatted values such as an identification string and a date string.
The terminal performs basic validation, for example checking that the identification string matches a required pattern and that the date string represents a valid calendar date, and outputs a validated identification value and a validated authentication value.

### Step 2

The terminal prepares a request message containing the validated identification value and authentication value.
The terminal takes, as input, the validated values and session information, and serializes them into a structured message body with associated header fields.
The terminal applies a transformation from internal data structures (for example, key-value pairs) into a byte sequence compliant with a communication protocol, and outputs an encoded request payload ready for transmission.

### Step 3

The terminal transmits the encoded request payload to the server via an encrypted communication mechanism.
The terminal takes, as input, the encoded payload and a destination network address, and invokes a network stack to segment the payload into packets and to apply encryption using a session key.
The terminal outputs encrypted packets onto a physical communication medium such as a wireless channel or a wired link, thereby delivering the user's identification information and authentication information to the server.

### Step 4

The server receives and decrypts the encrypted packets from the terminal.
The server takes, as input, the network packets arriving at its network interface, reassembles them into the original encrypted payload, and performs decryption using cryptographic keys stored in secure memory.
The server outputs a decrypted request message and passes it to an application layer component for further processing.

### Step 5

The server parses the decrypted request message to extract the identification value and authentication value.
The server takes, as input, the raw message bytes, applies a parsing routine according to the message format, and maps the data into internal fields such as an identification field and an authentication field.
The server outputs a request object that contains these fields and discards malformed or extraneous data.

### Step 6

The server collates the extracted identification value and authentication value with an information set stored in a storage device.
The server takes, as input, the request object and formulates one or more query conditions based on the identification value and authentication value.
The server sends these conditions to a database management engine, which returns records that match the conditions, and the server outputs user information including usage state information and identifiers of subscribed services.

### Step 7

The server determines unsubscribed service information by comparing subscribed service identifiers with service catalog identifiers.
The server takes, as input, a list of subscribed service identifiers and a list of all service identifiers available in a catalog.
The server performs a set difference operation, implemented for example using hash-based lookup or sorted list comparison, and outputs a list of service identifiers that are present in the catalog but absent from the subscribed list, along with associated attributes such as names and categories, thereby forming unsubscribed service information.

### Step 8

The server generates a query sentence based on the user information, usage state information, and unsubscribed service information.
The server takes, as input, structured user attributes, a list of current services, and a list of unsubscribed services, and applies a template-filling or rule-based text construction routine.
The server concatenates phrases and inserts dynamic values such as service names and categories, and outputs a natural language query sentence that describes the current context and asks for additional relevant services.

### Step 9

The server generates a prompt sentence to be input to the generative AI model using natural language processing.
The server takes, as input, the query sentence and possibly other metadata such as service categories or user preferences, and transforms them through a natural language processing module that may reorder terms, add constraints, or normalize expressions.
The server outputs a refined prompt sentence that optimizes the generative AI model's ability to produce meaningful additional service information.

### Step 10

The server performs tokenization and embedding of the prompt sentence for input to the generative AI model.
The server takes, as input, the prompt sentence text and applies a tokenizer to split the text into tokens based on a predefined vocabulary.
The server maps each token to a numerical vector using an embedding matrix stored in memory, and outputs a sequence of embedding vectors representing the prompt sentence in a form suitable for neural network processing.

### Step 11

The server executes the generative AI model to generate additional service information.
The server takes, as input, the sequence of embedding vectors and propagates them through a neural network architecture such as a transformer with stacked attention layers and feedforward layers.
The server computes attention weights, intermediate activations, and output logits, applies a decoding strategy such as beam search or top-k sampling, and outputs a sequence of tokens that form one or more candidate textual descriptions of additional service information.

### Step 12

The server decodes the output tokens of the generative AI model into structured additional service information.
The server takes, as input, the generated token sequence, converts it back into text, and parses this text to identify service names, identifiers, categories, and relevance indicators.
The server cross-references the identified services with the service catalog, filters out invalid entries, and outputs additional service information as a structured list of candidate services with associated scores or explanations.

### Step 13

The server receives voice information of the user from the terminal and preprocesses it into acoustic feature vectors.
The server takes, as input, a digital audio stream or audio frames transmitted by the terminal, applies signal processing operations such as framing, windowing, and spectral analysis, and computes acoustic features such as Mel-frequency cepstral coefficients or log-mel spectrograms.
The server outputs a time series of feature vectors that encode the spectral characteristics of the user's voice.

### Step 14

The server estimates an emotion index from the acoustic feature vectors.
The server takes, as input, the feature vector sequence and passes it through an emotion estimation network such as a recurrent or convolutional neural network followed by fully connected layers.
The server performs matrix multiplications, nonlinear activations, and aggregation of temporal features, and outputs an emotion index that quantitatively represents the emotional state of the user, such as a value on one or more affective dimensions.

### Step 15

The server calculates priority values for unsubscribed service information and additional service information using the emotion index and relevance scores.
The server takes, as input, the list of unsubscribed services, the list of additional services, relevance scores produced by the generative AI model, and the emotion index.
The server applies a priority setting algorithm, for example computing a weighted sum of relevance and emotional suitability, and outputs a priority value for each service item that will determine its order and emphasis in subsequent presentation.

### Step 16

The server assembles user information, unsubscribed service information, additional service information, and priority values into a structured data format.
The server takes, as input, all relevant data objects and organizes them into a hierarchical structure with defined fields for identification data, contract data, current services, and candidate services with priorities.
The server serializes this structure into a compact representation suitable for efficient transmission, and outputs a single structured response message.

### Step 17

The server encrypts and transmits the structured response message to the terminal.
The server takes, as input, the structured response and an active secure session context, applies symmetric encryption to the message payload, and encapsulates the encrypted data into protocol packets.
The server outputs the packets to the communication interface, thereby delivering the prioritized service information back to the terminal.

### Step 18

The terminal receives and decrypts the structured response message from the server.
The terminal takes, as input, encrypted packets arriving over the network, reassembles them into the full payload, and uses stored session keys to perform decryption.
The terminal outputs a decrypted structured message that contains user information, unsubscribed service information, additional service information, and associated priority values.

### Step 19

The terminal parses the structured message and maps its contents to user interface components.
The terminal takes, as input, the structured message, applies a parser that interprets the schema, and constructs internal data structures representing lists of current services and candidate services with their priority values and attributes.
The terminal outputs ready-to-render data objects and layout directives that specify how each item should be positioned or emphasized on the display.

### Step 20

The terminal renders a visual display of the usage state information, unsubscribed service information, and additional service information according to the priority values.
The terminal takes, as input, the ready-to-render data and layout directives, executes drawing operations using a graphics subsystem, and orders the items on-screen based on the computed priorities.
The terminal outputs a visual interface in which higher-priority services are placed more prominently or highlighted, enabling the user to efficiently review and select services.

### Step 21

The user reviews the displayed information and selects one or more services for subscription or further inquiry.
The terminal takes, as input, the user's touch or click actions on specific interface elements, maps these actions to corresponding service identifiers, and generates a follow-up request message.
The terminal outputs a new structured request that reflects the user's choices, which can be transmitted to the server for registration or additional processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional customer support and recommendation systems that operate in physical or online service environments typically rely on static rule sets, manually designed recommendation logic, or simple matching between user attributes and pre-defined service offerings. Such systems are often implemented as fixed decision trees or hard-coded mappings within application software running on general-purpose computing hardware. As a result, these systems exhibit several technical limitations.

First, conventional systems generally process customer identification information and service usage history in isolation from real-time user context, such as the user's current emotional state derived from voice interactions. The processing pipeline is not designed to dynamically adapt the prioritization or presentation order of service proposals based on such contextual information. Consequently, the system's control logic for generating and presenting service proposals cannot fully exploit the available input data to optimize the sequencing and relevance of information displayed on user devices, leading to suboptimal use of computing resources and communication bandwidth.

Second, existing architectures that use machine learning models often treat the models as black-box classifiers or scorers, without leveraging a generative AI model that is guided by explicit, structured prompt sentences derived from normalized customer attribute information. In many implementations, usage history and unsubscribed service data are either loosely integrated or only partially utilized, resulting in fragmented data flows, redundant database accesses, and inefficient use of processor and memory resources. The system is thus unable to transform heterogeneous customer data into a unified representation that can be effectively consumed by a generative AI model to produce coherent, individualized natural language outputs.

Third, typical client-server systems that provide service recommendations do not tightly integrate: (i) structured acquisition of personal identification information via wireless communication from a user-operated information processing apparatus; (ii) server-side aggregation and normalization of usage period information, usage status information, and unsubscribed service information; (iii) prompt sentence generation tuned to instruct a generative AI model; and (iv) real-time adjustment of the priority and presentation order of proposals using emotion analysis of user voice data. The lack of such integrated control results in fragmented processing stages, additional latency, and increased complexity in application-level code, thereby degrading the overall efficiency and responsiveness of the computing system.

Fourth, conventional systems typically return generic text blocks to the client device without separating them into machine-structured elements, such as short notification messages and detailed proposal content. This forces the client-side application to perform ad hoc parsing or to display less-contextualized content, which can increase processing overhead on the client, complicate UI logic, and reduce the determinism of presentation behavior. In addition, without a standardized representation of “service proposal information” on the server, subsequent updates and refinements to recommendation logic require extensive modifications across multiple software layers.

Accordingly, there is a need for an improved computer-implemented system that: (1) systematically acquires and aggregates customer usage history information from a storage device based on personal identification information received via wireless communication; (2) transforms the aggregated information into normalized customer attribute information; (3) generates structured prompt sentences that explicitly instruct a generative AI model to produce personalized proposal content and optimal talk; (4) extracts structured, display-ready components such as short notification messages and detailed proposal content from the generative AI model output; and (5) evaluates user emotional state from voice data to adjust the priority and presentation order of service proposals. Such a system should improve the technical functioning of the server-side processing pipeline, enhance the efficiency of natural language generation and presentation control, and reduce processing burdens on client devices by delivering structured, context-aware service proposal information.

The specific processing by the specific processing unit 290 of the data processing device 12 in Application Example 1 is realized by the following means.

The present invention provides a server comprising a processor configured to receive, via a communication interface, structured data including personal identification information from an information processing apparatus operated by a user over a wireless communication line; to extract the personal identification information from the structured data, access an information storage unit that manages usage history information in a storage device based on the personal identification information, acquire the usage history information, aggregate, by arithmetic processing, usage period information, usage status information, and unsubscribed service information included in the usage history information, and generate customer attribute information including the usage period information, the usage status information, and the unsubscribed service information; to convert the customer attribute information into a natural language expression and generate a prompt sentence that instructs a generative AI model to generate personalized proposal content and optimal talk for user interaction based on the customer attribute information; to input the generated prompt sentence into the generative AI model, acquire natural language text output from the generative AI model, extract at least a short notification message and detailed proposal content from the natural language text, and generate service proposal information to be provided to the user based on the extracted proposal content; to transmit the service proposal information as structured data toward the information processing apparatus and control so that the short notification message and the detailed proposal content are displayable on the information processing apparatus; and to analyze voice data of the user to evaluate an emotional state of the user and execute a priority setting algorithm that changes a presentation order or importance of the service proposal information based on a result of the evaluation. This enables the server to implement an integrated, computer-implemented pipeline that transforms heterogeneous customer data into normalized customer attribute information, guides a generative AI model through explicit prompt sentences to produce structured, personalized natural language proposals, and dynamically adjusts the prioritization and presentation of such proposals based on real-time emotion analysis, thereby improving the efficiency, adaptability, and technical performance of the overall recommendation and interaction system.

The term “processor” refers to a hardware-based or virtualized computation unit, such as a central processing unit or a processing core, that executes machine-readable instructions to perform data acquisition, data processing, control, and communication functions described in the present specification.

The term “communication interface” refers to a hardware and software combination that enables the server to send and receive data over a communication network, including interfaces for wired or wireless communication protocols.

The term “structured data” refers to data that is organized according to a predefined format or schema, such as key-value pairs, records, or objects, which can be parsed and processed by a computer program.

The term “personal identification information” refers to information that enables a particular user or customer to be identified within a system, such as an identification code, date of birth, or other unique attribute.

The term “information processing apparatus” refers to a client-side computing device operated by a user, such as a portable information terminal, a mobile communication terminal, or another general-purpose computing device capable of input, display, and communication.

The term “wireless communication line” refers to a communication path established using radio waves or similar wireless transmission technology, including but not limited to local wireless networks and wide-area wireless networks.

The term “information storage unit” refers to a logical component that manages storage and retrieval of information in a storage device, such as a database system or a data management module.

The term “storage device” refers to a hardware device that stores digital data, such as a magnetic disk, a solid-state drive, or a memory device.

The term “usage history information” refers to information that records how a user has used one or more services over time, including access records, transaction records, and other usage-related events.

The term “usage period information” refers to information indicating a length of time during which a user has been using a service, such as a duration from a service start date to a current date.

The term “usage status information” refers to information indicating a pattern or degree of use of a service by a user, including frequency of use, amount of use, and types of functions or contents used.

The term “unsubscribed service information” refers to information indicating services that are available to a user but have not yet been contracted, activated, or subscribed to by the user.

The term “customer attribute information” refers to information obtained by aggregating and normalizing usage period information, usage status information, unsubscribed service information, and related usage history data into a unified representation associated with a user.

The term “natural language expression” refers to text or speech content represented in a human language, which can be read or understood by a human user.

The term “prompt sentence” refers to a natural language instruction or query that is provided as input to a generative AI model to specify a task, such as generating personalized proposal content or optimal talk based on customer attribute information.

The term “generative AI model” refers to a machine learning model that generates new natural language text or other content in response to input data, including models based on deep learning architectures trained on large-scale data.

The term “personalized proposal content” refers to content that recommends services or actions to a user, the content being generated according to usage history information, customer attribute information, or other user-specific data.

The term “optimal talk” refers to natural language expressions, such as phrases or scripts, that are generated to communicate proposed services or information to a user in a manner considered effective or appropriate for interaction.

The term “natural language text” refers to a sequence of characters or tokens representing sentences or phrases in a human language, generated or processed by a computer system.

The term “short notification message” refers to a relatively brief natural language text segment intended to notify a user of a proposal or information, typically suitable for display in a notification area of an information processing apparatus.

The term “detailed proposal content” refers to extended natural language text that describes specific proposals, conditions, or explanations in more detail than a short notification message.

The term “service proposal information” refers to structured information including at least a short notification message and detailed proposal content, which is generated for the purpose of presenting one or more service recommendations to a user.

The term “voice data” refers to digital data representing audio captured from a user's speech, suitable for analysis by a computer program to extract features related to content or emotion.

The term “emotional state” refers to a condition of a user's feelings or mood at a given time, such as satisfaction, frustration, excitement, or calmness, inferred from analysis of voice data or other behavioral signals.

The term “priority setting algorithm” refers to a computational procedure executed by a processor to determine and adjust priority values or presentation order of information items based on one or more input factors, such as an evaluated emotional state.

The term “presentation order” refers to an order in which multiple items of information, such as service proposals, are arranged and displayed to a user on an information processing apparatus.

The term “importance” refers to a relative weight or ranking assigned to an item of information, such as a service proposal, which influences how prominently or how early the item is presented to a user.

The term “emotional feature values” refers to numerical or categorical values derived from voice data that characterize aspects of a user's emotional state, such as intensity, valence, or specific emotion categories.

The term “display priority” refers to a numerical or ordinal value that determines a precedence level for displaying a particular item of service proposal information compared to other items.

In one embodiment, a server cooperates with a terminal operated by a user to generate and present personalized service proposals using a generative AI model guided by a structured prompt sentence. The server is implemented on a computing platform including at least one processor, a main memory, a non-volatile storage device, and a network interface. The processor executes server-side software such as an application framework (for example, a web framework implemented in an object-oriented language), a database management system (for example, a relational database engine), and an AI inference client library for communicating with a generative AI model. The terminal is implemented as a portable information processing apparatus, such as a smartphone or tablet, including a central processing unit, a display device, an audio input device, a wireless communication module, and an operating system that provides APIs for network communication, user interface rendering, and audio capture.

The terminal provides an application that allows the user to input personal identification information such as an identification code and a date of birth. The terminal uses a graphical user interface library provided by the operating system to render input fields, buttons, and notification elements. The terminal structures the user input into a data object represented as a key-value mapping (for example, a dictionary-like structure with fields “customer_id” and “date_of_birth”) and converts this mapping into structured data suitable for transmission over a wireless communication line, such as a byte sequence formatted according to a standardized markup or serialization format. The terminal uses a networking library (for example, an HTTP client library) to encapsulate the structured data in a request message and sends this message to the server via a wireless communication network such as a local wireless network or a wide-area cellular network.

The server receives the structured data through the network interface and passes it to a communication module implemented in software. The server uses a parsing component (for example, a serializer or deserializer implemented in the server-side framework) to parse the structured data and extract the personal identification information. The server uses this personal identification information as a key to access an information storage unit that manages usage history information stored in a storage device. The information storage unit is implemented as a relational database schema with tables for user profiles, service usage logs, and service catalog entries. The server uses a database access component such as an object-relational mapping layer to issue queries that retrieve usage history records associated with the identified user.

The server aggregates the raw usage history information into usage period information, usage status information, and unsubscribed service information. The server calculates the usage period information by subtracting a service start date stored in the database from a current system date maintained by the operating system, thereby obtaining a number of days or months of service use. The server derives usage status information by applying statistical computations to usage logs, such as counting access events, summing usage time intervals, and categorizing accessed content types. The server identifies unsubscribed service information by comparing a set of available service identifiers from the service catalog with a set of subscribed service identifiers stored in the user profile, and computing a set difference.

The server combines these computed elements into customer attribute information, which is represented as a normalized data structure including fields for usage period, usage intensity metrics, preferred content categories, and candidate unsubscribed services.

The server converts the customer attribute information into a natural language expression and generates a prompt sentence that instructs a generative AI model to produce personalized proposal content and optimal talk. In one embodiment, the server stores a prompt template in a configuration module, where the template includes placeholders for the usage period information, usage status information, and unsubscribed service information. The server performs string formatting operations to substitute the actual values derived from the customer attribute information into the template. For example, the server may generate a prompt sentence such as:
“The following is customer data:
Customer ID: A123456789
Date of Birth: 1990-05-10
Usage Period: 24 Months
Usage status: frequent video streaming usage, occasional music streaming usage
Unsubscribed services: premium sports package, kids package.

Using this information, generate a personalized offer and an optimal talk script to propose suitable services to this customer in a retail store. Include specific service names and explain why they match the customer. Use clear and concise language.”

Alternatively, the server may generate a more generic prompt sentence when designing or testing the system, such as:
“Tell me how to input a customer's ID number and date of birth, match them with a database using a server-side program, and generate a personalized offer based on service usage period, usage status, and non-subscribed services.”

The server interacts with a generative AI model that is implemented as a neural network-based language model. In one embodiment, the generative AI model uses a transformer architecture comprising multiple layers of self-attention, feed-forward networks, and normalization operations. The model is trained on a large corpus of text using a language modeling objective where the model predicts a next token given preceding tokens. During training, the model updates internal weight parameters using a gradient-based optimization algorithm such as stochastic gradient descent with adaptive learning rates. The training process minimizes a loss function such as cross-entropy between predicted token distributions and ground-truth tokens. The model can further be fine-tuned on domain-specific text containing service proposal dialogues and customer communications so that it learns patterns of effective proposal phrasing and polite interaction.

The server does not treat the generative AI model as an opaque component; instead, the server constrains and guides the model's behavior through structured prompt design and through selection of specific model configuration parameters. For example, the server sets a temperature parameter and a maximum token length in the AI inference request to control the degree of randomness and the length of the generated text. The server uses the customer attribute information to define explicit constraints in the prompt sentence, including which service categories may be recommended and how many items should be proposed. This non-conventional use of generative AI model configuration and prompt conditioning results in outputs that are more tightly aligned with system constraints and that reduce the need for downstream filtering or rewriting.

The server transmits the prompt sentence and optional control parameters (such as maximum length and temperature) to the generative AI model through an AI inference client library.

The AI inference client library constructs a request message that encodes the prompt sentence as a sequence of tokens according to a predefined tokenizer, transmits the token sequence to a remote or local inference engine running on dedicated hardware such as a graphics processing unit or a tensor processing unit, and receives the generated token sequence as a response. The server then decodes the token sequence back into natural language text.

The server processes the natural language text generated by the generative AI model to extract structured components such as a short notification message and detailed proposal content. In one embodiment, the server specifies in the prompt sentence that the model should output text in a segmented format, for example by including markers such as “SHORT_MESSAGE:” and “DETAILS:”. The server uses pattern matching or parsing logic to split the generated text at these markers and store the segments into fields of a service proposal information structure. Because the server explicitly conditions the output format through the prompt sentence, the server can avoid complex and error-prone free-form text parsing, thereby reducing processing time and computational overhead.

The server generates service proposal information that includes the short notification message, the detailed proposal content, and optionally an optimal talk script intended for human staff. The server represents this information as a structured data object containing fields such as “short_message”, “detailed_offer”, and “talk_script”. The server transmits this structured data to the terminal via the network interface, using a communication protocol such as HTTP over a wireless communication line. The server manages data compression and response size by limiting the number of proposal items and the length of descriptions according to configuration parameters stored in a system configuration module, thereby reducing communication load.

The terminal receives the structured service proposal information and uses a deserialization component to reconstruct the short notification message and detailed proposal content. The terminal displays the short notification message in an operating system notification area or within a dedicated region of the application's user interface. When the user interacts with the notification, the terminal transitions to a detail screen where the terminal renders the detailed proposal content and, if applicable, the optimal talk script. The terminal uses layout components and text rendering engines provided by the operating system to optimize readability and interaction.

The server also processes voice data captured from the user. The terminal acquires voice data through a microphone, encodes the audio into a digital audio stream (for example, a sequence of pulse-code-modulated samples), and transmits the audio stream or extracted acoustic features to the server. The server uses an audio processing module to transform the raw audio into a feature representation such as Mel-frequency cepstral coefficients, pitch contours, and energy envelopes. The server inputs these features into an emotion classification model, which may be implemented as a neural network architecture such as a convolutional neural network, a recurrent neural network, or a combination thereof. The emotion classification model is trained on labeled voice data where each sample is associated with an emotional category or continuous arousal-valence values, using a supervised learning algorithm and a loss function such as categorical cross-entropy or mean squared error.

The server converts the output of the emotion classification model into emotional feature values that represent an estimated emotional state of the user. The server executes a priority setting algorithm that uses these emotional feature values along with the customer attribute information to compute display priority scores for each proposal item in the service proposal information. For example, the server may assign higher priority to less complex or more reassuring proposals when the emotional feature values indicate a negative or anxious state, and assign higher priority to promotional or upgrade proposals when the emotional feature values indicate a positive and engaged state. The priority setting algorithm computes numerical scores based on a combination of weights applied to emotional categories, service categories, and historical acceptance rates. The server then sorts the proposal items according to the computed display priority scores and updates the presentation order in the service proposal information before transmitting it to the terminal.

This integrated processing flow yields several technical effects. Because the server aggregates usage history information into normalized customer attribute information before generating the prompt sentence, the server reduces the number of database accesses and the size of data transmitted to the generative AI model. This improves calculation efficiency and decreases response latency. Because the server employs explicit prompt structuring and model configuration, the generative AI model generates more constrained and relevant natural language text, thereby reducing downstream filtering and post-processing, which improves processing speed and reduces memory use on the server. Because the server splits the generated text into structured components and sends only the necessary segments to the terminal, the system reduces communication bandwidth usage and simplifies the user interface logic on the terminal, which in turn reduces client-side processing load.

Moreover, the emotion-based priority setting algorithm modifies the order and emphasis of proposals at the server side, which allows the server to avoid sending low-priority or contextually inappropriate proposals in some configurations. By doing so, the server reduces unnecessary data transmission and reduces the number of user interface updates required by the terminal. The combination of usage-based aggregation, generative AI model conditioning, and emotion-driven prioritization produces a specific technical improvement: the server can adaptively control both the content and the structure of proposal information based on multiple heterogeneous data sources, in a manner that is not achievable by simple rule-based automation or static recommendation tables.

The server uses non-conventional processing steps within the AI pipeline. Rather than directly mapping customer features to service identifiers, the server constructs a prompt sentence that encodes both data and constraints, allows the generative AI model to synthesize context-aware language, and then programmatically enforces a structured output pattern. This interplay between symbolic prompt design and subsymbolic neural generation yields a system where the computational load is redistributed: the generative AI model performs high-dimensional pattern synthesis, while the server performs rigid structural enforcement. This division of labor optimizes the use of hardware resources, as the neural computation is concentrated in dedicated inference hardware while the structural enforcement and aggregation are executed efficiently by the server CPU.

In other embodiments, the server may host the generative AI model locally rather than accessing a remote inference engine. In such embodiments, the server includes an accelerator device such as a graphics processing unit or a tensor processing unit, and the server loads the trained model parameters into memory for local inference. The server may batch multiple prompt sentences and process them concurrently to improve throughput. The server may also apply model distillation, quantization, or pruning techniques to reduce model size and inference latency, resulting in reduced power consumption and faster response times.

In another embodiment, the terminal may perform preliminary feature extraction or lightweight natural language post-processing to further reduce the load on the server. For example, the terminal may cache frequently used proposal templates and only request incremental updates from the server. The terminal may also occasionally transmit aggregated feedback data, such as which proposals were accepted or dismissed, to allow the server to adjust the weights used in the priority setting algorithm.

The described system focuses on internal technical processing rather than business logic. The aggregation of usage history into normalized customer attribute information, the structured generation and parsing of prompt sentences, the configuration and use of a generative AI model with specific architectural and training characteristics, and the emotion-based priority setting algorithm each operate at the level of data structures and computational operations.

These components interact to improve data management, reduce redundancy, enhance prediction relevance, and optimize communication and display behavior, thereby providing an improvement to computer technology itself rather than merely automating a preexisting human procedure.

Additional embodiments may vary specific implementation details while remaining within the scope of the claimed system. For example, the server may employ different database technologies, alternative feature extraction methods for voice data, or different neural architectures (such as encoder-decoder models or hybrid models combining rule-based and learned components). The terminal may be a desktop computer, a vehicle-mounted device, or a kiosk, as long as it is capable of sending structured data containing personal identification information, receiving structured service proposal information, and displaying the associated messages. In all such variations, the core aspects remain: the server generates and uses customer attribute information to construct a prompt sentence, the server conditions a generative AI model to produce structured, personalized natural language outputs, and the server adjusts presentation priority based on emotion analysis to improve technical performance of the overall system.

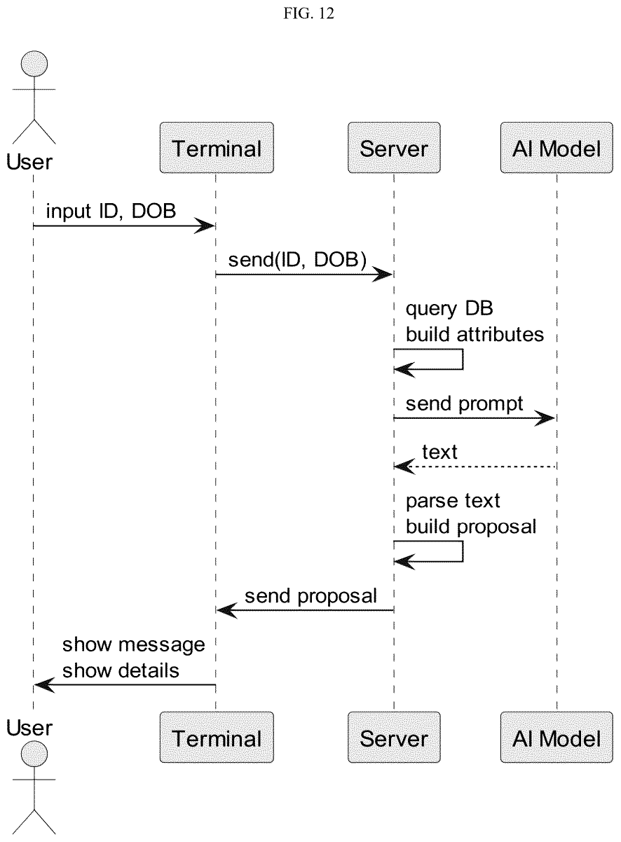

The following describes the processing flow using FIG. 12.

### Step 1

The user operates the terminal to start an application and display an input screen for personal identification information.
The terminal receives, as input, raw keystrokes or touch events corresponding to an identification code and a date of birth.
The terminal performs input validation by checking formats (for example, character type, length, and date validity) and, based on this validation, outputs either an error message to the display or a validated pair of values representing the identification code and the date of birth.

### Step 2

The terminal converts the validated identification code and date of birth into a structured data object, such as a key-value mapping with fields for “customer_id” and “date_of_birth.”
The terminal takes, as input, the validated identification code and date of birth and applies a serialization process to transform them into a structured byte sequence suitable for network transmission.
The terminal outputs a request payload encapsulating the structured data and then uses a networking library to send this payload over a wireless communication line to the server.

### Step 3

The server receives the request payload through its communication interface and passes the payload to a parsing module.
The server takes, as input, the structured data containing the identification code and date of birth and performs a parsing operation to reconstruct the original key-value mapping.
The server outputs extracted values for the identification code and date of birth, which are then used as input parameters for accessing an information storage unit that manages usage history information in a storage device.

### Step 4

The server accesses the information storage unit (for example, a relational database) to retrieve usage history information corresponding to the identification code and date of birth.
The server takes, as input, the identification code and date of birth and executes database queries that filter records in user profile and usage log tables.
The server outputs a collection of usage history records, including service start dates, usage timestamps, service identifiers, and subscription status flags, which are forwarded to an aggregation module.

### Step 5

The server aggregates the usage history records into usage period information, usage status information, and unsubscribed service information.
The server takes, as input, the raw usage history records and performs data processing operations such as date subtraction to compute usage durations, event counting to compute usage frequencies, and set operations to detect services that are available but not yet subscribed.
The server outputs structured fields for usage period, usage status metrics, and a list of unsubscribed services, which are combined into customer attribute information represented as a normalized data structure.

### Step 6

The server converts the customer attribute information into a natural language description and constructs a prompt sentence for a generative AI model.
The server takes, as input, the normalized customer attribute information and applies string formatting logic to insert values into a stored prompt template.
The server outputs a complete prompt sentence, such as:
“The following is customer data:
Customer ID: A123456789
Date of birth: 1990-05-10
Usage period: 24 months
Usage status: frequent video streaming usage, occasional music streaming usage
Unsubscribed services: premium sports package, kids package.
Using this information, generate a personalized offer and an optimal talk script to propose suitable services to this customer in a retail store. Include specific service names and explain why they match the customer. Use clear and concise language.”

### Step 7

The server sends the prompt sentence and model control parameters (such as maximum output length and temperature) to the generative AI model via an AI inference client.
The server takes, as input, the prompt sentence and configuration parameters and encodes the prompt into a token sequence according to a tokenizer associated with the generative AI model.
The server outputs an inference request that is transmitted to an inference engine running the generative AI model, and the server then waits for a generated token sequence as a response.

### Step 8

The server receives a generated token sequence from the generative AI model and decodes it into natural language text.
The server takes, as input, the sequence of tokens produced by the generative AI model, applies a detokenization process that maps tokens back to characters and words, and stitches them into coherent sentences.
The server outputs a natural language text block that contains, for example, a short greeting, specific service recommendations, justifications, and an optimal talk script.

### Step 9

The server parses the natural language text to extract a short notification message and detailed proposal content.
The server takes, as input, the generated natural language text and performs pattern matching or delimiter-based splitting (for example, using markers such as “SHORT_MESSAGE:” and “DETAILS:” if included in the prompt).
The server outputs separated text segments: one segment representing a short notification message (for example, “Hello, we have a special offer just for you!”) and another segment representing detailed proposal content and, optionally, a talk script.

### Step 10

The server combines the extracted segments into service proposal information represented as a structured data object.
The server takes, as input, the short notification message and the detailed proposal content and assigns them to fields within a service proposal structure, optionally adding metadata such as proposal identifiers and timestamps.
The server outputs structured service proposal information ready to be transmitted over the network.

### Step 11

The server analyzes voice data from the user to evaluate an emotional state used to adjust priority of service proposals.
The server takes, as input, voice data or precomputed acoustic features transmitted from the terminal and applies feature extraction and classification algorithms to derive emotional feature values such as arousal and valence scores.
The server outputs an estimated emotional state, represented as numerical or categorical values, that will be used as input to a priority setting algorithm.

### Step 12

The server executes a priority setting algorithm to assign display priority scores to each proposal item contained in the service proposal information.
The server takes, as input, the emotional feature values and the service proposal information (including service categories and attributes) and performs a weighted scoring computation where weights depend on emotion category and service characteristics.
The server outputs updated service proposal information in which each proposal item has an associated display priority score and, if applicable, a modified presentation order based on these scores.

### Step 13

The server transmits the prioritized service proposal information to the terminal via the communication interface.
The server takes, as input, the structured service proposal information with updated presentation order and performs a serialization and packaging operation to embed the data into a response message compliant with a network protocol.
The server outputs a response payload that is sent over the wireless communication line to the terminal.

### Step 14

The terminal receives the response payload and reconstructs the service proposal information.
The terminal takes, as input, the serialized structured data from the server and uses a deserialization module to restore the short notification message, detailed proposal content, and any priority or ordering information.
The terminal outputs internal data structures containing these elements, which are passed to the user interface layer.

### Step 15

The terminal displays the short notification message and, upon user interaction, presents the detailed proposal content according to the priority order determined by the server.
The terminal takes, as input, the internal data structures holding the service proposal information and uses the operating system's UI components to render the short notification message in a notification area and the detailed proposal content in a full-screen or dialog view.
The terminal outputs visual and, where appropriate, auditory presentations that guide the user through the prioritized proposals, thereby completing a full cycle of data processing from user input to AI-driven, prioritized content display.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented customer support and recommendation systems suffer from several technical limitations when handling heterogeneous user information, historical usage data, and real-time interaction data such as voice input. First, existing systems typically rely on fixed rule sets or manually designed mapping logic to classify user information into service categories and to generate recommendations. This causes the processor to perform repetitive, rigid control flows that do not adapt to complex or evolving data patterns in large-scale databases, thereby limiting the effectiveness of automated assistance and wasting computing resources.

Second, although machine learning models have been applied to some classification or recommendation tasks, these models are usually tightly coupled to specific data schemas and task definitions, and they do not flexibly handle newly emerging service types or diverse user utterances without retraining. Consequently, the processor must be reconfigured or redeployed when services, input formats, or business rules change, which impairs scalability and maintainability of the underlying information processing architecture.

Third, many existing systems are not designed to integrate structured usage history information, unstructured user input, and emotional state information obtained from voice analysis in a unified processing pipeline. As a result, the processor often executes separate subsystems that are loosely integrated, leading to redundant database access, fragmented memory usage, and increased latency in providing context-aware recommendation outputs. In particular, known systems do not efficiently combine tabular usage data analysis with generative AI-based reasoning via dynamically constructed prompt sentences, and therefore cannot fully exploit generative AI models to refine classification and prioritization of information in real time.

Fourth, current systems rarely adjust the priority of information and recommendations based on dynamically inferred emotional states of users. Even when some form of emotion detection is available, it is typically not fed back into the control logic that governs data classification and recommendation display. As a result, the processor cannot optimize the ordering, selection, or emphasis of outputs so as to allocate computational and display resources toward information that is most relevant under the user's current state, thereby degrading the overall responsiveness and usability of the system from a technical perspective. Accordingly, there is a need for an improved computer-implemented system in which a processor can (i) automatically acquire and analyze usage history information from storage devices using efficient tabular data processing, (ii) dynamically generate prompt sentences for a generative AI model based on structured analysis results and unstructured user information, (iii) integrate the generative AI model's outputs into the core control flow for classifying information into services and generating individualized proposal content, and (iv) evaluate user emotional states from voice information and automatically adjust priority control of classification results and proposal content displayed on a terminal. Such a system should technically improve the way the processor manages data flows, model interactions, and user interface outputs, thereby enhancing processing efficiency, adaptability, and responsiveness of the overall computing environment.

The specific processing by the specific processing unit 290 of the data processing device 12 in Example 2 is realized by the following means.

The present invention provides a server comprising a processor configured to receive individual identification information and other information from a user via an interface, acquire, based on the individual identification information, usage history information including usage period information, usage status information, and non-contracted service information from a record information storage device, analyze the acquired usage history information by executing tabular data processing in an information processing program execution environment so as to extract, for each individual, usage frequency information, usage tendency information, and candidate non-contracted service information, generate, based on the extracted information and the received information, a prompt sentence that instructs a generative information processing model to identify related services and to generate proposal content suitable for the individual, input the prompt sentence to the generative information processing model and acquire, from the generative information processing model, analysis result information including service classification results and proposal content optimized for the individual, convert the acquired analysis result information into a structured data format and transmit the structured data via a communication network to a terminal so that the terminal displays the proposal content, analyze voice information of the user to evaluate emotional state information, and execute a priority setting algorithm that adjusts, based on the emotional state information and the usage tendency information, priority information of the service classification results and the proposal content displayed on the terminal. This enables an improved computer-implemented processing pipeline in which the server dynamically combines structured tabular analysis and generative AI-based reasoning, reduces rigid rule-based control, optimizes database access and data flow management, and adaptively controls output prioritization in response to user state, thereby enhancing processing efficiency, scalability, and responsiveness of the overall information processing system.

The term “processor” refers to a hardware-based or virtual computation unit, such as a central processing unit or a processing core, that is configured to execute instructions of an information processing program to perform data acquisition, analysis, control, and communication operations.

The term “individual identification information” refers to information that enables a computing system to uniquely or quasi-uniquely identify an individual entity, such as an identifier, a date of birth, or a combination of multiple attributes.

The term “user” refers to a human operator, such as a staff member or an end customer, who interacts with the system via an interface to provide input information and to receive outputs such as classification results and proposal content.

The term “interface” refers to a hardware and software combination, such as a graphical user interface, an application programming interface, or an input/output device, that enables the user or an external component to exchange information with the processor.

The term “record information storage device” refers to a data storage component, such as a database system, a storage server, or a non-volatile memory apparatus, that stores usage history information, service information, and other related data in a retrievable manner.

The term “usage history information” refers to information indicating past usage of one or more services by an individual, including at least usage period information and usage status information associated with the services.

The term “usage period information” refers to information that represents a time interval during which an individual has used a particular service, such as a duration from a start date to a current date or to an end date.

The term “usage status information” refers to information that represents how an individual has used a service, such as usage frequency, usage amount, usage pattern, or type of operations performed.

The term “non-contracted service information” refers to information that indicates services that are available in the system but are not currently contracted or subscribed to by a particular individual.

The term “tabular data processing” refers to a data processing operation in which information is represented and manipulated in a table-like structure, such as rows and columns, enabling operations including grouping, aggregation, filtering, and joining.

The term “information processing program execution environment” refers to a software execution context, such as a runtime environment or an operating system environment, in which an information processing program is executed by the processor to perform data analysis and control tasks.

The term “usage frequency information” refers to information that indicates how often an individual uses a service, such as a number of accesses during a unit period or a count of specific operations.

The term “usage tendency information” refers to information that indicates characteristic patterns or preferences of service usage by an individual, derived from usage history information and statistical or analytical processing.

The term “candidate non-contracted service information” refers to information that identifies one or more non-contracted services that are selected as potential recommendation targets based on usage frequency information, usage tendency information, or other criteria.

The term “prompt sentence” refers to a sequence of one or more natural language expressions or structured textual instructions that is generated by the processor and provided as input to a generative information processing model to cause the model to perform a requested analysis or generation task.

The term “generative information processing model” refers to a learned model, such as a generative artificial intelligence model or a language model, that generates output information, including analysis result information and proposal content, in response to an input prompt sentence.

The term “analysis result information” refers to information output by the generative information processing model that includes at least service classification results or proposal content, or both, derived from the input prompt sentence and underlying model parameters.

The term “proposal content” refers to information representing one or more recommended services, plans, or options tailored for an individual, and may further include reasons, explanations, or justification for each recommendation.

The term “structured data format” refers to a data representation format that explicitly defines a structure of data elements and their relationships, such as a hierarchical or tabular schema, including but not limited to a markup-based or notation-based format.

The term “communication network” refers to a wired or wireless communication infrastructure, such as a local area network, a wide area network, or a public network, that enables data transmission between the server and one or more terminals.

The term “terminal” refers to an information processing apparatus, such as a personal computer, a mobile device, or a tablet device, that communicates with the server via the communication network and presents classification results and proposal content to the user.

The term “service classification result” refers to information indicating how received information or data items have been associated with or assigned to one or more services based on analysis by the generative information processing model or other processing.

The term “voice information” refers to data representing acoustic signals of speech uttered by a user, which may be acquired via a microphone or another audio input device and processed for analysis of content or emotional state.

The term “emotional state information” refers to information that represents an estimated emotion or affective state of a user, such as satisfaction, frustration, interest, or neutrality, inferred from voice information or other behavioral signals.

The term “priority information” refers to information that indicates an order, weight, or level of importance for presenting or processing one or more items, such as classification results or proposal content, within the system.

The term “priority setting algorithm” refers to a computational procedure executed by the processor that determines or modifies priority information, including an output order or a presentation degree of information items, based on one or more inputs such as emotional state information and usage tendency information.

The server, the terminal, and the user cooperate to implement embodiments of the invention as described below. Each embodiment is intended to support and exemplify the scope of the claims without limiting the invention thereto.

The server operates on a hardware platform that includes at least one processor, a main memory, a non-volatile storage device, and a network interface. The server uses an operating system (for example, a general-purpose server operating system) and an information processing program execution environment (for example, a Python runtime) to execute application software. The server accesses a record information storage device, such as a relational database management system running on a storage server, and communicates with one or more terminals over a communication network.

The terminal operates on a hardware platform that includes a processor, a display device, an input device such as a touch panel or keyboard, a microphone, and a network interface. The terminal executes a web browser or a dedicated client application. The terminal presents user interface screens implemented in a markup language, a style description language, and a client-side script language, and exchanges data with the server using a network protocol.

The user operates the terminal to input individual identification information and other information, including free-form text and voice information. The user views classification results and proposal content displayed on the terminal and may provide further input based on the displayed information.

The server uses the record information storage device to store usage history information, including usage period information, usage status information, and non-contracted service information. The server stores this information in structured data tables, each table having columns for keys and attributes such as an individual identifier, a service identifier, timestamps, usage amounts, and status flags. The server uses indexes and normalized schemas to allow efficient retrieval and aggregation of data for each individual.

The server uses an information processing program execution environment to perform tabular data processing. The server loads subsets of the usage history information into in-memory table structures, such as data frames, and applies grouping, aggregation, filtering, and joining operations. The server thereby derives usage frequency information and usage tendency information. For example, the server aggregates records per service identifier and per time period to compute counts and total usage amounts, and the server compares these aggregates across services to determine relative preference. The server identifies candidate non-contracted service information by joining contracted services and available services and selecting services not present in the contracted set.

The server uses the result of this tabular data processing to generate a prompt sentence as a natural language sequence to be supplied to a generative AI model. The server constructs the prompt sentence by inserting specific usage frequency information, usage tendency information, and candidate non-contracted service information into a templated or programmatically assembled text. The prompt sentence explicitly instructs the generative AI model to produce analysis result information for classification and proposal generation.

In one example, the server generates a prompt sentence such as:
“Customer A has used the music streaming service almost every day for the last 12 months and often listens to playlists during commuting hours. However, Customer A has not subscribed to any video streaming service. Based on this usage pattern and the list of available but unsubscribed services, generate specific proposal contents, including a recommendation for a video streaming service and any bundle plans with the existing music streaming service. Explain why each proposal is appropriate for Customer A.”

In another example, the server generates a prompt sentence such as:
“Customer B regularly uses more than 20 GB of mobile data per month, frequently streams videos on the go, and sometimes exceeds the current data limit, incurring overage charges. Customer B is not subscribed to any large data plan or home broadband service. Based on this usage status, what kind of service upgrades or bundles should be proposed to Customer B? Provide multiple concrete proposals along with clear reasons that store staff can easily explain.”

In another example, the server generates a prompt sentence such as:
“Customer C has been using the basic mobile phone service for 36 months and frequently makes international calls to family abroad, resulting in high monthly call charges. Customer C occasionally streams music but has not subscribed to any international calling pack or music add-on. Based on this situation, generate proposal contents that recommend suitable international call packs and optional services, and explain how these proposals can reduce costs and increase satisfaction for Customer C.”

The server supplies such prompt sentences to a generative AI model implemented as a neural network-based generative information processing model. The server uses a model architecture that includes an input embedding layer, a plurality of attention layers, and an output generation layer. The server represents each token of the prompt sentence as a vector embedding, applies multi-head self-attention and feed-forward transformations, and decodes output tokens to generate natural language text that forms the analysis result information.

The server trains or uses a generative AI model that has been trained on a corpus including service descriptions, usage scenarios, and dialog data. The server uses a supervised or semi-supervised learning method with a loss function such as cross-entropy between predicted tokens and target tokens. The server updates weights of the neural network using an optimization algorithm, such as a gradient-based method, and may apply techniques such as learning rate scheduling, regularization, and data augmentation. The server may further fine-tune the model using domain-specific data that include examples of mapping usage patterns to proposals, so that the model's internal parameters encode relationships between structured usage features and textual proposal patterns.

The server generates features for the generative AI model by encoding not only raw text but also normalized numerical indicators derived from usage history information. The server may encode usage frequency information and usage tendency information as textual descriptors, such as “very frequent usage,” “moderate usage,” or “rare usage,” based on threshold rules applied to aggregated values. The server may additionally encode ranking of candidate non-contracted services by describing them as “top three recommended categories” or “high-priority potential services.” In this manner, the server incorporates a non-conventional, rule-based translation from high-dimensional tabular data into compact textual prompts that are optimized for generative AI input, thereby reducing the dimensionality of numeric data and constraining the search space of the generative AI model. This contributes to improved inference speed and stability of the generative AI model when running on the server's processor.

The server uses the generative AI model to produce analysis result information that includes both service classification results and proposal content. The server configures decoding parameters such as a temperature parameter and a maximum output length to balance diversity and determinism in the generated content. The server may implement post-processing rules that extract structured elements from the generated text, such as service identifiers, recommendation strength levels, and explanatory reasons. The server thereby converts the free-form generative output into a structured data format suitable for downstream processing and display.

The server converts the analysis result information into a structured data format, such as a hierarchical notation format, and stores it in memory or in the record information storage device. The server includes metadata, such as individual identifiers, timestamps, model version identifiers, and confidence measures. The server transmits the structured data to the terminal via the communication network using a request-response protocol. The server may compress the data or selectively transmit only differences from a previous result to reduce communication load.

The terminal receives the structured data and parses it using client-side script code. The terminal updates display elements to present the proposal content and service classification results. The terminal uses layout rules to highlight high-priority recommendations and to group related items together. The terminal can present multiple proposals as separate selectable elements, allowing the user to quickly navigate among recommendation options. The user may provide voice information through the microphone of the terminal. The terminal captures the voice information and transmits corresponding audio data to the server. The server processes the voice information using a voice analysis module that includes a feature extraction stage and an emotional state inference stage. The server converts the audio waveform into acoustic features such as mel-frequency cepstral coefficients, pitch contours, and energy features. The server inputs these features to an emotional state classification model, which may also be implemented as a neural network comprising convolutional layers or recurrent layers, or as a transformer-based model for sequential data.

The server trains the emotional state classification model with labeled audio data that associate acoustic features with emotional categories, using a supervised learning method and an appropriate loss function. The server uses the trained model to output emotional state information such as “positive,” “neutral,” “frustrated,” or “confused,” along with confidence scores. The server combines the emotional state information with usage tendency information to compute priority information for classification results and proposal content.

The server executes a priority setting algorithm that adjusts the order and emphasis of displayed items. For example, the server may increase the priority of cost-saving proposals when the emotional state indicates frustration about billing, or highlight simple, low-cognitive-load recommendations when the emotional state indicates confusion. The server encodes this priority information in the structured data it sends to the terminal, such as by including priority ranks and emphasis flags. The server thereby controls how the terminal allocates screen space and visual emphasis, leading to lower cognitive load for the user and reduced time to locate relevant information.

The terminal uses the received priority information to change the presentation order, font size, or color highlighting. The terminal may place high-priority items at the top of the screen and collapse or hide low-priority items until the user explicitly expands them. This selective rendering reduces the amount of data that needs to be drawn and can also reduce the amount of data that needs to be transmitted when the server sends only top-ranked items.

The server thereby improves computer technology in several ways. By performing pre-aggregation and feature extraction on usage history information using tabular data processing, the server reduces the amount of raw data that must be provided to the generative AI model. This decreases memory usage and reduces the number of tokens needed in the prompt sentence, which shortens inference time for the generative AI model on the processor. By encoding usage patterns into semantically meaningful textual descriptors using non-conventional thresholds and ranking rules, the server constrains the generative AI model's effective input space, which improves accuracy and stability of the generated analysis result information.

The server further improves data management by maintaining a structured representation of both raw usage history information and derived features. The server stores relationships between individuals, services, and recommendations in normalized data tables, enabling efficient querying and consistency checking. The server's integration of structured data analysis with generative AI reasoning avoids the need for separate, siloed systems and reduces duplicate storage and redundant computation.

The server improves communication efficiency by transmitting only structured, filtered, and prioritized proposal content, rather than raw logs or unprocessed model outputs. The server can adjust the granularity of transmitted data based on network conditions or terminal capabilities. For example, the server can transmit a compact summary of proposals to a resource-constrained terminal and only transmit detailed justifications upon user request.

The server's use of emotional state information to control the priority setting algorithm provides a non-conventional mechanism for adaptive computation. Instead of applying a static display order, the server dynamically reallocates processing and display resources toward items that are likely to be most relevant under current user conditions. This reduces the number of interactions required for the user to identify an appropriate proposal and thus shortens overall interaction time. In aggregate, this yields a technical effect of improved responsiveness and reduced processor and network load in the system.

The server executes these processes according to program instructions stored in the non-volatile storage device. The program instructions include modules for database access, tabular data processing, feature extraction, prompt sentence generation, generative AI model interaction, voice feature extraction, emotional state classification, priority calculation, and communication control. The modules exchange data through defined interfaces and data structures, such as intermediate in-memory tables and message objects. This modular design allows the server to parallelize certain tasks, such as performing usage aggregation and emotional state analysis concurrently, thereby improving throughput and scalability.

The terminal may implement alternative embodiments for user interaction. In one embodiment, the terminal is a personal computer with a large display and a pointing device, suitable for staff use in a fixed location. In another embodiment, the terminal is a handheld device used in a physical store to interact with customers. In yet another embodiment, the terminal is integrated into a kiosk system that automatically presents proposals directly to end customers, while still relying on the server's processing pipeline for data analysis and generative AI reasoning.

The server may also implement alternative configurations of the generative AI model. In one embodiment, the server uses a large-scale transformer-based language model hosted on a dedicated inference server. In another embodiment, the server uses a smaller, domain-specific generative model deployed locally to reduce network latency and dependency on external services. In yet another embodiment, the server uses a hybrid approach, where a local model handles routine proposals and an external, larger model is invoked only when complex or novel patterns are detected in the usage history information, as indicated by anomaly detection rules. These variations allow the system to balance computational cost, latency, and quality of generated proposal content.

The server can also vary the algorithms for mapping numeric features into textual descriptors in the prompt sentence. The server may use quantile-based thresholds, clustering-based labels, or learned mapping functions that convert aggregated statistics into descriptive phrases. By tuning these mapping rules based on empirical evaluation, the server can further improve the generative AI model's performance on the specific domain, which is a concrete optimization of the computer-implemented pipeline rather than a mere automation of human reasoning.

The user benefits from the improved technical performance of the system. The user receives recommendations that are computed more quickly and accurately than in systems that either rely solely on fixed rules or use generative AI without structured pre-processing and priority control. The user can interact with the terminal under varied network and device conditions while the server adapts the data format and volume to maintain a responsive experience. The combination of structured analysis, generative AI reasoning, and emotional state-based prioritization accordingly constitutes a technical solution that enhances the operation of the underlying computer system itself.

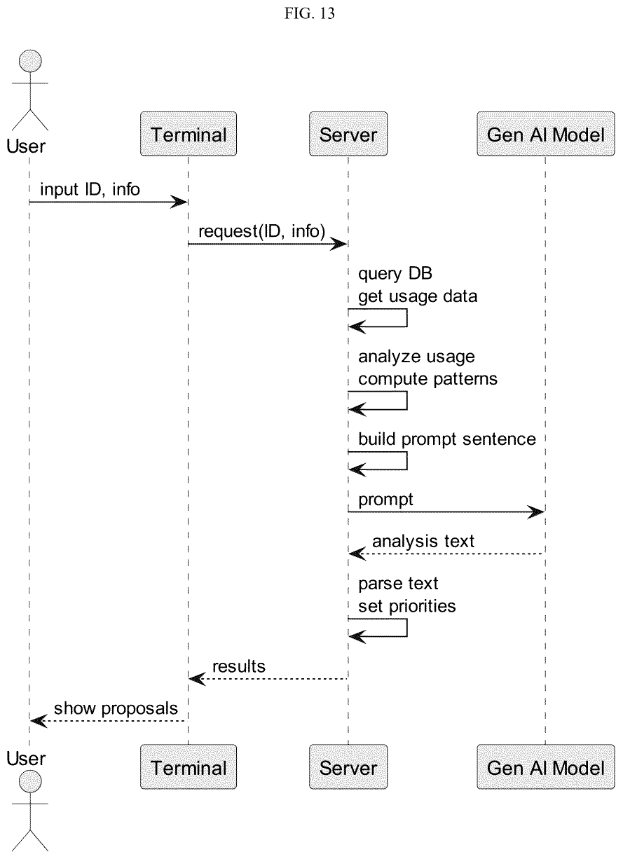

The following describes the processing flow using FIG. 13.

### Step 1

The user operates the terminal to input individual identification information. The terminal displays an input screen including fields for an individual identifier and at least one additional attribute such as a date of birth. The user enters the values and activates a send control (for example, a button). The terminal takes the entered text as input, validates format (for example, checking length and allowed characters), and constructs a request message containing the individual identification information. The terminal outputs this request message to the server via a communication network.

### Step 2

The server receives the request message from the terminal. The server takes, as input, the individual identification information contained in the request message. The server parses the message, extracts the individual identifier and other attributes, and validates them against predefined rules. The server then generates one or more database queries targeting a record information storage device that stores usage history information and service information. The server outputs structured query commands as input to the record information storage device.

### Step 3

The server acquires usage history information from the record information storage device. The server takes, as input, the results of the structured query commands, including records for contracted services, timestamps of usage events, and lists of available services. The server converts the raw result sets into in-memory table structures. The server performs data operations such as joining, filtering, and sorting to separate contracted service records, usage log records, and non-contracted service records. The server outputs organized usage history information, including usage period information, usage status information, and non-contracted service information, in a normalized internal format.

### Step 4

The server computes usage frequency information and usage tendency information by tabular data processing. The server takes, as input, the organized usage history information. The server groups records by individual identifier and service identifier, aggregates numeric fields such as counts and durations, and applies arithmetic operations to calculate frequencies, averages, and ratios. The server further applies comparison operations and threshold rules to determine relative tendencies, such as “high frequency” use or “low frequency” use. The server outputs derived data objects representing usage frequency information, usage tendency information, and candidate non-contracted service information for the individual.

### Step 5

The server generates a prompt sentence for a generative AI model. The server takes, as input, the usage frequency information, usage tendency information, and candidate non-contracted service information. The server converts numeric values into textual descriptors according to predetermined mapping rules and inserts these descriptors into a natural language template. The server concatenates text segments, including instructions and constraints, to form a coherent prompt sentence that describes the individual's situation and requests generation of proposal content. The server outputs the constructed prompt sentence as a text string.

### Step 6

The server transmits the prompt sentence to the generative AI model and obtains analysis result information. The server takes, as input, the constructed prompt sentence. The server formats the prompt sentence and model parameters into a model invocation request and supplies this request to the generative AI model hosted in an execution environment. The generative AI model internally encodes the prompt sentence, propagates activations through layers of a neural network, and generates output tokens representing analysis result information, including proposal content and service classification indications. The server receives this generated text as output from the model and may parse it to identify segments such as recommended services, priorities, and explanations. The server outputs structured analysis result information derived from the generated text.

### Step 7

The server evaluates emotional state information based on voice information. The server takes, as input, voice data representing speech from the user, which is transmitted from the terminal. The server applies a signal processing procedure to extract acoustic features such as frequency domain coefficients, pitch, and intensity from the voice data. The server supplies these features to an emotional state classification model, which computes scores for multiple emotional categories. The server interprets the scores as emotional state information and selects a predominant emotional state. The server outputs emotional state information, optionally including confidence measures and category labels.

### Step 8

The server calculates priority information for classification results and proposal content. The server takes, as input, the structured analysis result information from the generative AI model and the emotional state information. The server applies a priority setting algorithm that maps combinations of usage tendency information and emotional state information to priority scores. The server adjusts ranking values, importance flags, and presentation attributes for each item of classification result and proposal content. The server outputs augmented analysis result information that includes priority information associated with each item.

### Step 9

The server converts the augmented analysis result information into a structured data format and sends it to the terminal. The server takes, as input, the prioritized classification results and proposal content. The server encodes these data into a hierarchical structure including fields for identifiers, text descriptions, priority scores, and display hints. The server may apply compression or selection algorithms to limit the number of items based on priority thresholds. The server then transmits the structured data as a response message over the communication network. The server outputs the response message to the terminal.

### Step 10

The terminal receives the response message and updates the display for the user. The terminal takes, as input, the structured data transmitted by the server. The terminal parses the hierarchical structure, extracts proposal content, classification results, and priority information, and applies layout rules to render these elements. The terminal arranges items on the display in an order determined by the priority information and may apply visual emphasis (such as highlighting or enlarged fonts) to higher priority items. The terminal outputs a user interface screen that shows the recommended services and associated explanations.

### Step 11

The user reviews the displayed information and optionally provides additional feedback. The user takes, as input, the classification results and proposal content shown on the terminal. The user may select specific proposals, request alternative proposals, or provide new voice or text input expressing preferences or reactions. The user's actions generate further input to the terminal, such as touch events or additional voice data. The terminal outputs updated request messages to the server based on this feedback, which can cause the server to repeat at least a subset of the preceding steps to refine the proposal content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that route user inquiries and generate responses suffer from several technical limitations. First, when a system receives unstructured natural language input from a user, the mapping from the input text to an internal processing target (for example, a department, function, or workflow) is often implemented as fixed keyword rules or shallow pattern matching. Such rule-based modules do not adapt well to variations in user language, domain updates, or complex multi-intent requests, which leads to frequent misclassification and requires manual maintenance of large rule sets. As the volume and diversity of inquiries increase, these architectures become fragile and computationally inefficient, because every request must be evaluated against many rules or heuristics.

Second, conventional systems typically treat emotional information in user voice or text, if used at all, as an auxiliary display for human operators, not as a first-class signal that dynamically modifies machine processing. Emotion analysis results are seldom integrated into the core routing logic, priority scheduling, or into the content and style of machine-generated guidance. As a result, the processing pipeline is effectively blind to user emotional state at the system level, and the system cannot algorithmically adjust priority queues or response generation behavior in accordance with real-time emotional conditions.

Third, even when generative AI models are introduced to analyze text and create responses, they are often invoked in a naive manner: a single generic prompt is reused for disparate users, different contexts, and different workflow stages. This static prompt design causes instability in model outputs, inconsistent quality, and difficulties in controlling output formats. It also prevents the system from exploiting contextual data such as user attributes, usage history, or previously inferred emotions to drive the generative model. Consequently, the generative model is underutilized as a computing component and behaves as a black-box text generator rather than as a controllable module in a larger information processing pipeline.

Fourth, current systems generally lack an integrated mechanism that couples (i) user identification and retrieval of structured user attribute information (such as usage period, usage status, and unsubscribed items), (ii) emotion-aware priority control, and (iii) dynamic generation of prompt sentences for a generative AI model at multiple pipeline stages, including classification of inquiries, generation of proposal content, and generation of dialogue scripts. Without this coupling, the system cannot maintain a coherent state across these stages, which leads to redundant computation (for example, repeating the same analysis multiple times), latency in generating suitable guidance, and inconsistent user experiences. Accordingly, there is a need for a technical framework in which a processor orchestrates a sequence of machine operations that: (1) derive structured user attribute information from identification information, (2) compute and update an emotional state from voice or text signals, (3) synthesize these internal states into dynamically constructed prompt sentences to be supplied to a generative AI model, (4) obtain analysis results and generated content from the model, and (5) automatically route, prioritize, and format guidance information for visual and/or audio output. Such a framework should improve the robustness, adaptability, and controllability of the entire information processing pipeline, reduce reliance on brittle rule sets, and enhance computational efficiency and responsiveness when handling large volumes of heterogeneous user inquiries.

The specific processing by the specific processing unit 290 of the data processing device 12 in Application Example 2 is realized by the following means.

The present invention provides a server comprising a processor and a storage device, the processor being configured to receive, via an interface, identification information and inquiry information from a user terminal, to search a user information storage region in the storage device based on the received identification information and to acquire structured user attribute information including at least a usage period, a usage status, and one or more unsubscribed items, to generate a first prompt sentence based on the acquired user attribute information and the inquiry information for causing a generative AI model to specify a related processing target, to input the first prompt sentence into the generative AI model and to receive from the generative AI model an analysis result in natural language, to automatically classify the inquiry information into the related processing target based on the analysis result, to input voice data acquired from a voice acquisition device into a speech recognition module and an emotion analysis module, to estimate an emotional state of the user based on output of the emotion analysis module, and to set a processing priority of at least the inquiry information and the classification result according to the estimated emotional state, to generate, based on the user attribute information and the emotional state, at least one second prompt sentence for causing the generative AI model to generate proposal content or a dialogue script, to input the at least one second prompt sentence into the generative AI model and to obtain the proposal content or the dialogue script from the generative AI model, to generate guidance information for presentation to the user or to a responding operator based on the proposal content or the dialogue script, and to output the guidance information in real time via at least one of a visual display device and an audio output device. This enables the routing, prioritization, and response generation pipeline to be executed as a unified, emotion-aware computation that dynamically controls the behavior of the generative AI model through context-dependent prompt sentences, thereby improving classification accuracy, reducing manual rule maintenance, stabilizing output formats of generated content, enhancing utilization of user attribute information and emotional signals inside the processing pipeline, and increasing overall efficiency and responsiveness of the computer-implemented information processing system.

The term “identification information” refers to information that enables a system to uniquely or sufficiently specify a user or customer, and includes, for example, an identifier, an account number, a membership number, a login name, or a combination of such identifiers with demographic information such as a date of birth.

The term “inquiry information” refers to information representing a request, question, complaint, or instruction provided by a user to a system, typically in natural language text or speech, and used by the system to determine an appropriate processing target or response.

The term “user attribute information” refers to structured data associated with a user that has been derived from stored records based on identification information, and includes at least a usage period, a usage status, and unsubscribed items, as well as other profile and behavioral attributes.

The term “usage period” refers to a duration during which a user has used at least one service or product, and is typically represented as a length of time between a start date of usage and a current date or an end date of usage.

The term “usage status” refers to information indicating how a user has used one or more services or products, and may include, for example, usage frequency, recent activity, transaction history, or patterns of use over time.

The term “unsubscribed items” refers to services, products, or service options that are available in a system but for which a user does not currently hold an active subscription, contract, or entitlement.

The term “storage device” refers to a hardware component or combination of components that stores digital data, including non-volatile storage such as a magnetic disk, an optical medium, or a semiconductor memory, and volatile storage such as a random access memory.

The term “user information storage region” refers to a logical or physical data structure within a storage device in which user attribute information, including usage period, usage status, and unsubscribed items, is stored in association with identification information.

The term “interface” refers to a hardware and/or software mechanism through which a processor exchanges data with a user terminal, and includes, for example, a network interface, an application programming interface, a graphical user interface, or a web service endpoint.

The term “generative information processing apparatus” refers to an information processing component that executes a generative AI model, receives a prompt sentence as input, and outputs natural language text or other generated data based on the prompt sentence.

The term “generative AI model” refers to a machine learning model configured to generate natural language or other structured output data from input data including prompt sentences, and typically implemented using a neural network trained on large-scale datasets.

The term “prompt sentence” refers to a text sequence supplied to a generative AI model that specifies, in natural language or a structured instruction format, a context and a requested task, including, for example, classification, proposal generation, or dialogue script generation.

The term “related processing target” refers to an internal processing unit, workflow, function, or service category within a system to which inquiry information is to be routed or assigned, such as a billing process, a contract-change process, or a technical-support process.

The term “analysis result” refers to output data generated by the generative AI model in response to a prompt sentence, including, for example, a classification label, an explanation, proposed content, or a dialogue script.

The term “classification result” refers to information indicating an assigned related processing target for given inquiry information, the classification result being derived from at least the analysis result provided by the generative AI model.

The term “voice acquisition device” refers to hardware configured to capture sound, including speech from a user, and to convert the sound into digital voice data, such as a microphone or an array of microphones.

The term “speech recognition module” refers to a software or hardware component that receives voice data and outputs corresponding text data by recognizing spoken language contained in the voice data.

The term “emotion analysis module” refers to a software or hardware component that receives at least one of text data and voice-related features and outputs an estimated emotional state and, optionally, a confidence value corresponding to the emotional state.

The term “emotional state” refers to a machine-estimated representation of a user's affective condition, which may include categories such as joy, anger, sadness, surprise, calmness, or neutrality, and may optionally include intensity or confidence scores.

The term “processing priority” refers to a parameter or value used by a system to determine an order, urgency, or mode of processing of inquiry information, classification results, or other tasks in relation to different requests.

The term “priority setting algorithm” refers to a computational procedure executed by a processor that calculates a processing priority based on one or more inputs, including at least an emotional state, a confidence degree, user attribute information, and a classification result.

The term “proposal content” refers to generated information that describes recommended products, services, options, or actions tailored to a user, based on user attribute information, usage data, and optional emotional state.

The term “dialogue script” refers to generated text that specifies a sequence of utterances or phrases to be used in a conversation with a user, including content, ordering, and expression style suitable for a given context and emotional state.

The term “guidance information” refers to information derived from at least one of proposal content and a dialogue script that is formatted for presentation to a user or a responding operator, and that assists in providing explanations, recommendations, or instructions.

The term “visual display device” refers to a hardware component configured to visually present information, including, for example, a head-mounted display, a panel display, or a projection device.

The term “audio output device” refers to a hardware component configured to output sound, including, for example, a speaker, a headset, or an earphone.

The term “user terminal” refers to an electronic apparatus operated by a user that communicates with the server, and includes, for example, a portable terminal, a stationary terminal, a head-mounted device, or another computing device.

The term “responding operator” refers to a human operator, such as a staff member or agent, who receives guidance information from the system and uses the guidance information when interacting with a user.

The term “natural language processing” refers to a set of algorithmic techniques by which a processor analyzes, interprets, or transforms natural language text, including operations such as tokenization, parsing, semantic analysis, classification, and text generation.

The term “output format” refers to a structure or layout specification for data generated by a generative AI model, including, for example, the presence of section headings, bullet points, dialogue labels, or length constraints, as defined or implied by a prompt sentence.

The term “instruction content” refers to the part of a prompt sentence that specifies the task or behavior requested from the generative AI model, such as identifying a processing target, generating proposal content, or rewriting a dialogue script with a particular tone.

The term “response mode” refers to a manner in which a system or an operator replies to a user, including, for example, the degree of politeness, level of detail, channel selection (text or audio), and emphasis on explanation, apology, or promotion.

The term “real time” refers to operation in which guidance information is generated and output with sufficiently low delay relative to ongoing user interaction such that the information can be used during a live conversation or session without perceptible interruption.

In one embodiment, a server, a plurality of terminals, and one or more user devices cooperate to implement the claimed system. The server includes at least one processor, a main memory, a non-volatile storage device, and a network interface. The terminals include, for example, a portable information processing device, a stationary information processing device, and a head-mounted display device. The user devices include at least a voice acquisition device and optionally a visual display and an audio output device integrated into the terminal.

The server executes an operating system such as a general-purpose server operating system, a database management system such as a relational database engine, a natural language processing framework, a speech recognition module, an emotion analysis module, and a generative AI model execution environment. The server stores user information, inquiry information, generated prompt sentences, analysis results, proposal content, and dialogue scripts in structured data records.

The server stores user attribute information in a user information storage region of the storage device. The user information storage region is organized as one or more relational tables or document collections. In one example, a user table stores an internal user identifier, one or more external identifiers, a date of birth, and static profile attributes. A usage table stores, for each user identifier and service identifier, a start timestamp, an optional end timestamp, a number of usage events, and aggregated usage metrics such as average frequency per day or per week. An unsubscribed table stores, for each user identifier, identifiers of service items that are available in the system but not currently subscribed. These tables are indexed by the internal user identifier, thereby enabling efficient retrieval based on received identification information.

The server receives identification information and inquiry information from a terminal through the network interface. The terminal transmits these data via a secure communication protocol. The processor converts the received data into internal data structures, such as records containing fields for the user identifier, a timestamp, and inquiry text. The server searches the user information storage region based on the user identifier and locates the corresponding records. The server computes a usage period by subtracting the earliest usage timestamp from a current system time. The server computes usage status statistics, such as counts of events in specific categories, using aggregation functions. The server determines unsubscribed items by computing a set difference between a stored set of available services and a stored set of subscribed services.

The server generates user attribute information in a structured representation. In one embodiment, the processor constructs a key-value structure where keys include “usage_period”, “usage_status”, and “unsubscribed_items”, and values store the computed period, aggregated usage statistics, and a list of unsubscribed service identifiers. This representation is reused in subsequent computation, which avoids querying the database multiple times for the same information and thereby reduces database access latency and network load within the server's internal bus.

The server executes a speech recognition module and an emotion analysis module for processing voice data. The terminal captures user voice using a microphone and transmits digitized audio samples to the server. The server applies a speech recognition module that performs acoustic feature extraction (for example, Mel-frequency cepstral coefficients or filterbank features) and decodes the feature sequence using a statistical model or a neural sequence model to obtain a text transcription. The server provides the transcription and optional prosodic features such as pitch contours and energy profiles to the emotion analysis module.

The server implements the emotion analysis module as a classifier that maps features derived from the text and prosodic signals to an emotional state label. In one embodiment, the emotion analysis module comprises a neural network with multiple layers, including an input embedding layer, one or more recurrent or transformer layers, and an output layer. The module computes an emotional state, such as joy, anger, sadness, or neutral, and a corresponding confidence value. The server stores the emotional state and the confidence value in association with the current inquiry and the user identifier.

The server executes a generative AI model that has been trained as a language model on a large corpus. The generative AI model can be implemented as a transformer-based neural network having multiple attention layers, feed-forward layers, and normalization layers. The model parameters are learned by minimizing a loss function such as cross-entropy between predicted tokens and observed tokens during training. The server stores the model parameters in memory or loads them from the storage device. The server executes the model on a computing unit such as a graphics processing unit or a tensor processing unit, which accelerates matrix multiplication and attention operations.

The server generates a first prompt sentence to control the behavior of the generative AI model during classification of inquiry information. The prompt sentence includes at least the inquiry information and the user attribute information. In one example, the server constructs a prompt sentence as follows:
“Read the following user request and output only the most relevant service category from this list: [billing, technical support, contract change, cancellation, general inquiry]. User attributes: has used core services for 24 months, frequently accesses usage history, and has not subscribed to any premium options. Request: ‘I changed my address last month but my bill still goes to the old address.’”

The server generates this prompt sentence by concatenating predefined template strings with values extracted from the user attribute information and the inquiry text. In one embodiment, the server applies natural language processing techniques to normalize and segment the inquiry text, remove redundant content, or detect multiple intents. The server selects an appropriate template based on a detection result, and thereby dynamically changes the instruction content and output format described in the prompt sentence. This dynamic prompt generation enables the generative AI model to receive explicit constraints regarding allowed categories and output format, which improves classification accuracy and reduces post-processing complexity.

The server inputs the first prompt sentence into the generative AI model using an inference function. The model performs tokenization of the prompt sentence, maps tokens to embedding vectors, processes them through the transformer layers, and produces probability distributions over output tokens. The model then samples or selects tokens to generate an output sequence, which includes a category name. The server extracts the category name, verifies that it belongs to one of the pre-specified categories, and uses it as a classification result. Because the prompt sentence defines the allowable categories and output format, the server can parse the output with a simple fixed rule and does not require complex pattern recognition. This reduces the computational cost and error rate in interpreting the model output.

The server sets a processing priority of the inquiry information by executing a priority setting algorithm. The algorithm takes as inputs the emotional state, the confidence value, the user attribute information, and the classification result. The server can implement the algorithm as a weighted scoring function. For example, the server can compute a base score from the classification result (for example, a cancellation category yields a higher base score than a general inquiry), then adjust the score based on the emotional state (for example, anger increases the score) and usage period (for example, long-term users receive higher priority).

The server then assigns a priority level such as high, medium, or low based on the computed score intervals. This process is performed entirely within the server's computational environment and results in a priority value used by internal schedulers and queues.

The server generates at least one second prompt sentence for generating proposal content and dialogue scripts. In this context, the server uses the user attribute information, the emotional state, and the classification result as input features. In one example, the server generates a prompt sentence for proposal content as:
“User has used basic connectivity services for 18 months and frequently streams video content. The user has not subscribed to any high-speed add-on plans. The current emotional state is ‘joy’ with high confidence. Based on these attributes, generate personalized proposal content recommending one or more add-on plans, including a brief explanation of benefits in under 120 words.”

The server then generates a prompt sentence for a dialogue script as:
“You are a conversation coach for support staff. Convert the following proposal content into a short dialogue script of 6-8 sentences that a staff member can speak to the user. Use polite and friendly language, and end with a question confirming interest. Adjust the tone to match a user who is currently joyful and satisfied. Proposal content: [insert previously generated proposal].”

The server supplies each of these prompt sentences to the generative AI model. The generative AI model uses its trained parameters to condition the output on the provided context. The server captures the generated proposal content and dialogue script, stores them as text sequences, and associates them with the inquiry and user identifier.

The terminal presents the guidance information to the user or a responding operator. When the terminal is a portable device with a display, the terminal receives the guidance information from the server and renders it using graphical elements such as headings, bullet lists, and separate sections for recommended actions and key phrases. When the terminal is a head-mounted device, the terminal displays short segments of the dialogue script within a limited field of view so that a responding operator can read them while maintaining eye contact with the user. The terminal can also request audio output from the server, causing the server to send the dialogue script to a text-to-speech module that produces audio data. The terminal then plays this audio through a speaker or a headset.

The server, by dynamic generation of prompt sentences that explicitly encode user attribute information, emotional states, and output constraints, improves the technical behavior of the generative AI model. Unlike a static, generic prompt, the context-dependent prompt sentence narrows the model's output distribution toward a constrained set of valid categories or a specific structure of proposal content and dialogue scripts. This narrowing reduces misclassification frequency, reduces the need for extensive rule-based corrections after model output, and decreases both processing time and resource consumption on the server. Because the server reuses structured user attribute information across multiple processing stages, the server minimizes repeated database queries, which lowers input/output overhead and speeds up overall response time.

The server improves computer technology by integrating emotion analysis into the core decision-making loop rather than treating it as a mere annotation. The priority setting algorithm, which consumes the emotional state, influences the internal scheduling of tasks, the order in which threads handle requests, and the generation of subsequent prompt sentences. The inclusion of the emotional state in the second prompt sentence changes the style of generated dialogue scripts, enabling the model to produce content that is easier to parse and apply in emotionally sensitive contexts. This integration leads to a reduction in failed interactions and repeated inquiries, thereby reducing overall system load.

The generative AI model itself is implemented as a parameterized neural network that has been trained in advance using supervised or self-supervised learning. The server stores training data in a training dataset composed of pairs of input texts and target outputs. During training, the server computes a loss function, such as cross-entropy between predicted token probabilities and ground-truth tokens, and updates the model's weights using a gradient-based optimization algorithm. The server may also perform data augmentation by, for example, paraphrasing input sentences or injecting controlled noise, which improves model robustness to linguistic variation. This training modifies the internal representation of language in a way that enables the model to generalize across different inquiry types and user attributes.

The server further implements non-conventional procedures to structure internal data and control the generative AI model. For example, the server may enforce that every prompt sentence includes a machine-readable marker marking the beginning of a target section or the allowed set of categories. The server then parses model outputs by locating these markers, avoiding complex and error-prone natural language parsing. This data structuring and marker-based control contribute to computational efficiency and reduce error propagation in the pipeline.

The system yields technical effects beyond mere automation of human tasks. Because the server orchestrates a sequence of specialized modules and dynamically generated prompt sentences, the system reduces misrouting of inquiries, shortens processing times, and decreases the volume of reprocessed or escalated tickets. The use of a priority setting algorithm that incorporates emotional state and user attributes enables more efficient resource allocation on the server, leading to more stable response times. The combination of structured user attribute information and generative AI-driven dialogue scripts improves the consistency of on-screen and audio guidance, thereby reducing ambiguity and the need for further clarification messages, which translates into reduced network traffic between the server and terminals.

Alternative embodiments are possible within the same inventive concept. In one alternative, the server may use a different architecture for the generative AI model, such as a recurrent neural network or a convolutional sequence model, while still receiving a context-dependent prompt sentence. In another alternative, the emotion analysis module may be implemented as a combination of rule-based sentiment lexicons and machine learning classifiers. The system may also vary in the specific structure of user information storage regions, for example, using key-value stores instead of relational tables, so long as the server retrieves information representing usage period, usage status, and unsubscribed items.

In another embodiment, the terminal performs part of the natural language pre-processing, such as tokenization and language detection, before sending the data to the server. This reduces network bandwidth usage and server-side computation. In yet another embodiment, the priority setting algorithm is refined by a reinforcement learning process, where the server adjusts weights in the scoring function based on observed performance metrics, such as response time and user satisfaction indices. In each case, the fundamental mechanism of generating prompt sentences based on structured user attribute information and emotional state, invoking a generative AI model, and using the outputs for routing, prioritization, and guidance generation remains the same, and continues to yield the described improvements in accuracy, latency, and computational efficiency.

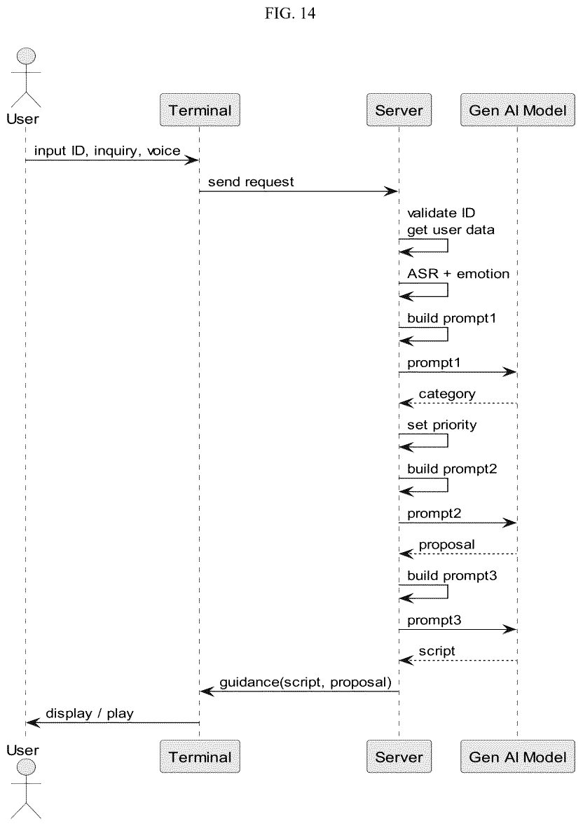

The following describes the processing flow using FIG. 14.

### Step 1

User operates a terminal to input identification information and inquiry information.
User enters, as input, data such as a user identifier and a date of birth into an input screen, and optionally types or speaks an inquiry such as “I changed my address but my bill still goes to the old address.”
Terminal captures this input, converts typed characters into a text string, encodes any spoken inquiry into audio data using an internal audio codec, and packages the user identifier, date of birth, inquiry text (if present), and raw audio (if present) into a request message.
Terminal outputs the request message with associated metadata (for example, device ID, timestamp) and transmits it to the server via a secure communication protocol.

### Step 2

Server receives the request message and validates identification information.
Server takes, as input, the user identifier, date of birth, and metadata from the terminal.
Server performs format checks (for example, verifying that the identifier matches a predefined pattern and that the date of birth is a valid calendar date) and executes a lookup operation in a user information storage region by running a query keyed on the user identifier and date of birth.
Server outputs a user profile record containing at least an internal user key and static attributes, or outputs an error response if no matching record is found.

### Step 3

Server retrieves and computes user attribute information including usage period, usage status, and unsubscribed items.
Server uses, as input, the internal user key obtained in Step 2.
Server queries a usage data structure to read multiple records of service usage events, then computes the usage period by subtracting the earliest usage timestamp from the current system time, and aggregates usage statistics such as counts per service and average frequency by applying summation and division operations over the event records.
Server queries a service subscription data structure to obtain the set of subscribed services and queries a master service data structure to obtain the set of all available services, then computes the set difference to derive unsubscribed items.
Server outputs structured user attribute information containing fields for usage period, usage status summaries, and a list of unsubscribed items.

### Step 4

Server processes audio data to obtain a text transcription.
Server receives, as input, the raw audio stream from the terminal when the user has spoken an inquiry or additional comments.
Server applies an audio preprocessing pipeline that performs framing, windowing, and extraction of acoustic features such as Mel-frequency cepstral coefficients, and then passes the feature sequence to a speech recognition module that decodes it using an acoustic model and a language model.
Server outputs a text transcription of the user's speech together with timing information for the recognized utterances.

### Step 5

Server estimates an emotional state from the user's speech and/or text.
Server uses, as input, the text transcription from Step 4 and optionally the original audio-derived features, as well as the inquiry text received directly from the terminal.
Server converts words in the text into token indices, maps them to embedding vectors, and feeds the embedded sequence and prosodic feature vectors into an emotion analysis module, which applies a neural network classifier to compute probability scores for multiple emotional categories.
Server outputs an emotional state label such as “anger,” “joy,” or “neutral,” along with a confidence score, and stores these values in association with the current inquiry.

### Step 6

Server constructs a first prompt sentence for classification using user attribute information and inquiry information.
Server takes, as input, the structured user attribute information from Step 3, the inquiry text (from the terminal and/or transcription), and optionally the emotional state from Step 5.
Server selects a template for classification, inserts textual descriptions of usage period, usage status, unsubscribed items, and the raw inquiry text into placeholder positions of the template, and concatenates them with an explicit instruction describing allowed service categories and required output format.
Server outputs a first prompt sentence such as:
“Read the following user request and output only the most relevant service category from this list: [billing, technical support, contract change, cancellation, general inquiry]. User attributes: has used core services for 24 months, frequently views billing history, and has not subscribed to any premium options. Request: ‘I changed my address last month but my bill still goes to the old address.’”

### Step 7

Server sends the first prompt sentence to a generative AI model and obtains a classification result.
Server uses, as input, the first prompt sentence generated in Step 6.
Server tokenizes the prompt sentence, maps tokens to vectors, and feeds the resulting sequence into a generative AI model that processes the sequence through multiple attention and feed-forward layers to predict output token probabilities; the model then generates an output sequence representing a category name.
Server parses the model output by reading the generated text, matches it against the predefined list of service categories, and selects a single related processing target such as “contract change.”
Server outputs a classification result indicating the chosen processing target.

### Step 8

Server computes a processing priority based on the emotional state, user attribute information, and classification result.
Server takes, as input, the emotional state and confidence score from Step 5, the user attribute information from Step 3, and the classification result from Step 7.
Server computes a numeric score by applying a priority setting algorithm, which assigns base scores to each processing target, adds or subtracts weights depending on the emotional state (for example, adding a positive offset for anger), and adjusts further based on usage period or other attributes; the server normalizes or bounds the score within a predetermined range.
Server maps the final score to a discrete priority class such as “high,” “medium,” or “low,” and outputs a processing priority value associated with the inquiry.

### Step 9

Server constructs a second prompt sentence for generating proposal content.
Server uses, as input, the user attribute information, the classification result, and optionally the emotional state and priority from previous steps.
Server selects a proposal template, fills in fields describing relevant services based on unsubscribed items, summarizes usage patterns in natural language, and includes a directive specifying length limits and required reasoning (for example, benefits to mention), together with any emotional context.
Server outputs a second prompt sentence such as:
“User has used basic connectivity services for 18 months and frequently streams video content. The user has not subscribed to any high-speed add-on plans. The current emotional state is ‘joy’. Based on these attributes, generate personalized proposal content recommending one or more add-on plans, including a brief explanation of benefits in under 120 words.”

### Step 10

Server invokes the generative AI model with the second prompt sentence to generate proposal content.
Server takes, as input, the second prompt sentence from Step 9.
Server processes the prompt sentence through the same generative AI model pipeline used in Step 7, allowing the network to condition on the described attributes and instructions and to produce a series of tokens that form a coherent recommendation paragraph.
Server decodes the token sequence into human-readable text, optionally trims the text to respect the specified length limit, and verifies that the content references allowed service items.
Server outputs proposal content text describing one or more recommended services with reasons.

### Step 11

Server constructs a third prompt sentence for generating a dialogue script.
Server uses, as input, the proposal content from Step 10 and the emotional state from Step 5.
Server selects a script-generation template that specifies the desired number of sentences, tone, and closing question, embeds the proposal content within a “Proposal content” section, and inserts emotional constraints such as “adjust the tone for an angry user” or “match a joyful mood.”
Server outputs a third prompt sentence such as:
“You are a conversation coach for support staff. Convert the following proposal content into a short dialogue script of 6-8 sentences that a staff member can speak to the user. Use polite and friendly language, and end with a question confirming interest. Adjust the tone to match a user who is currently joyful and satisfied. Proposal content: [insert proposal content].”

### Step 12

Server calls the generative AI model with the third prompt sentence and obtains a dialogue script.
Server takes, as input, the third prompt sentence from Step 11.
Server feeds the prompt into the generative AI model, which generates a sequence of sentences formatted as spoken lines; the server receives this output as a text string.
Server post-processes the script by splitting it into sentences, optionally adding speaker labels like “Staff:” and removing extraneous instructions or commentary, and stores the cleaned script as a structured dialogue representation.
Server outputs the finalized dialogue script ready for presentation or conversion to audio.

### Step 13

Server generates guidance information by combining proposal content, dialogue script, and priority.
Server uses, as input, the proposal content from Step 10, the dialogue script from Step 12, the classification result from Step 7, and the priority from Step 8.
Server constructs a guidance object that includes fields such as target department, priority level, key proposal points, and ordered script segments, and may reorder or highlight information depending on priority and emotional state.
Server outputs the guidance information in a format suitable for transmission to the terminal, such as a structured message containing text sections and display hints.

### Step 14

Terminal receives the guidance information and displays it to a responding operator or user.
Terminal takes, as input, the guidance object transmitted from the server.
Terminal parses the structure, maps proposal content to a summary area on a display, renders the dialogue script as line-by-line text with navigation controls, and visually indicates the processing priority using color or icons; in the case of a head-mounted display, the terminal selects only a subset of short phrases to show in the user's field of view.
Terminal outputs visual guidance on the display and logs user interactions such as scrolling, line selection, and script acknowledgment.

### Step 15

Terminal optionally requests audio output and plays synthesized speech.
Terminal uses, as input, a user action indicating a desire to hear the script or a configuration requiring spoken guidance.
Terminal sends a request identifying the dialogue script to the server, receives synthesized audio data generated by a text-to-speech module under the control of the server, and buffers the audio in local memory.
Terminal outputs the audio through a speaker or headset, thereby presenting the dialogue script as spoken guidance while simultaneously or alternately showing the corresponding text on the display.

### Step 16

User listens to or reads the guidance information and interacts with the system accordingly.
User receives, as input, the visual and/or audio guidance presented by the terminal.
User uses the displayed script as a reference when speaking to another person or responds to the guidance by selecting options or providing further input, such as accepting a recommended service or asking an additional question; the terminal captures these new actions and sends them back to the server as additional inquiry information.
User outputs, through speech or interface actions, follow-up information that becomes input to subsequent iterations of the processing flow, enabling continuous refinement of proposals and scripts.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

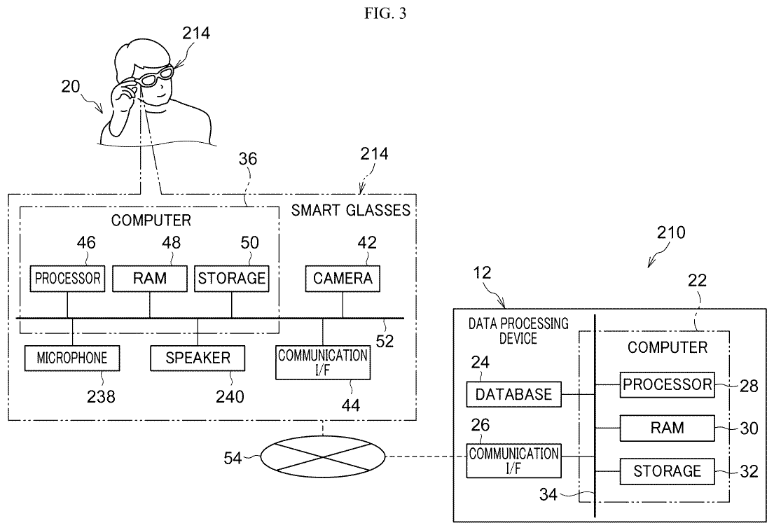

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

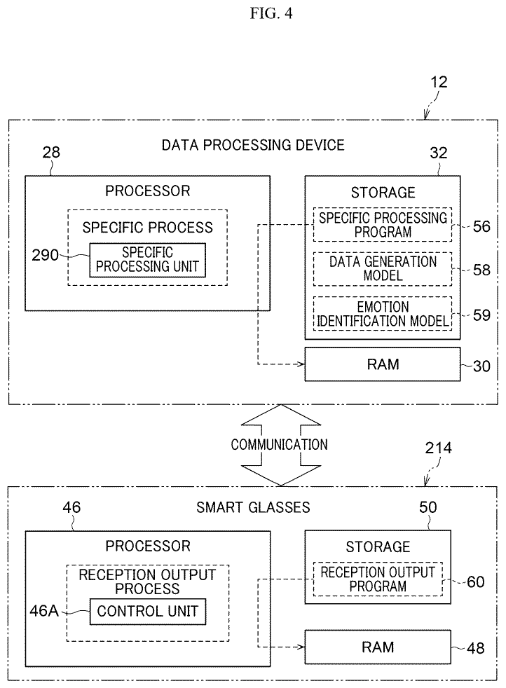

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

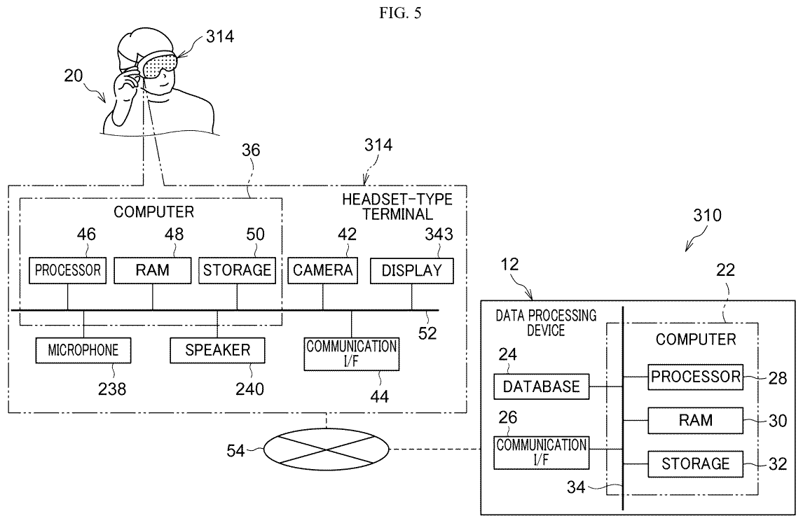

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

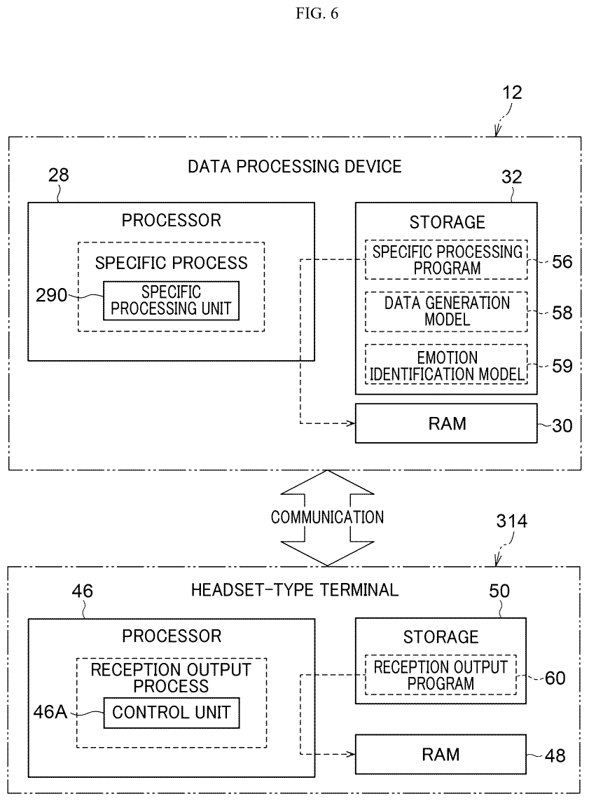

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

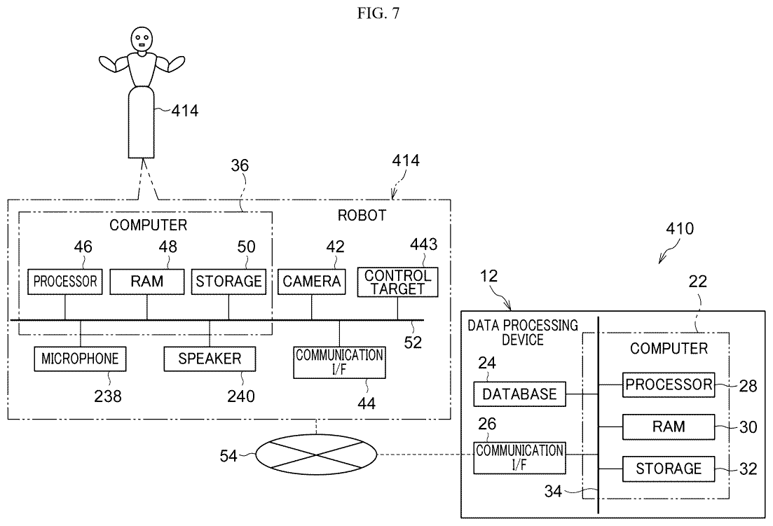

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

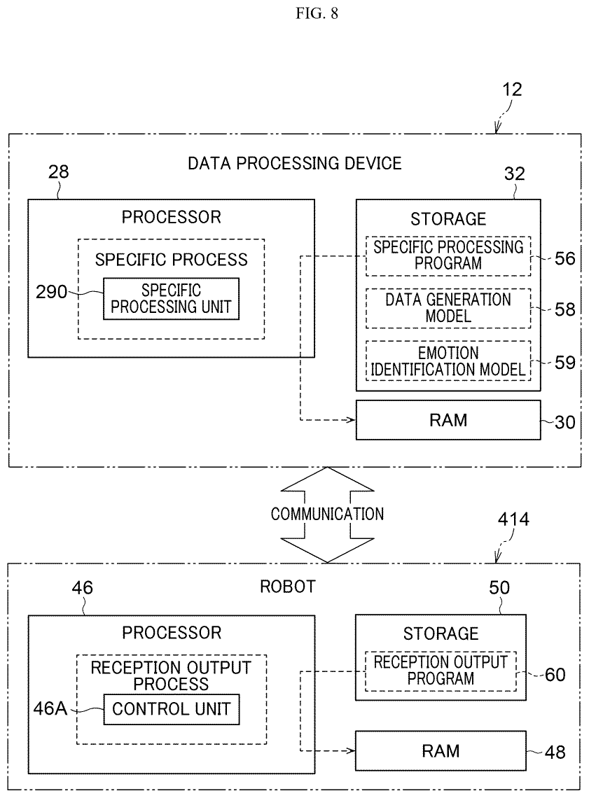

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

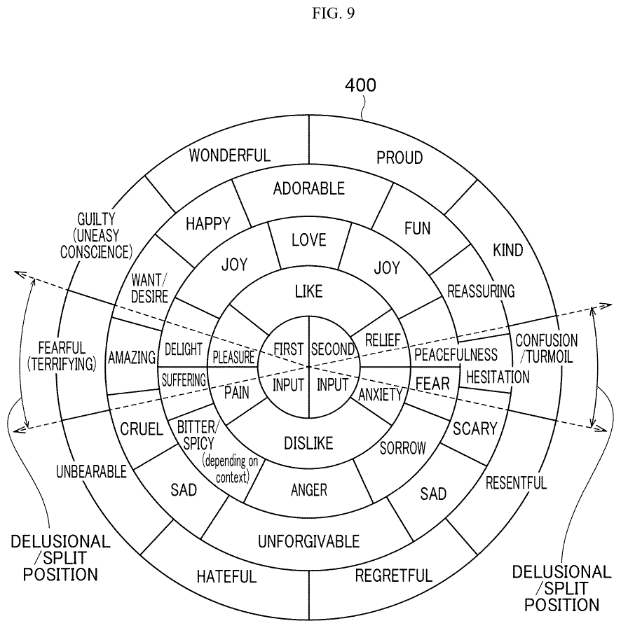

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

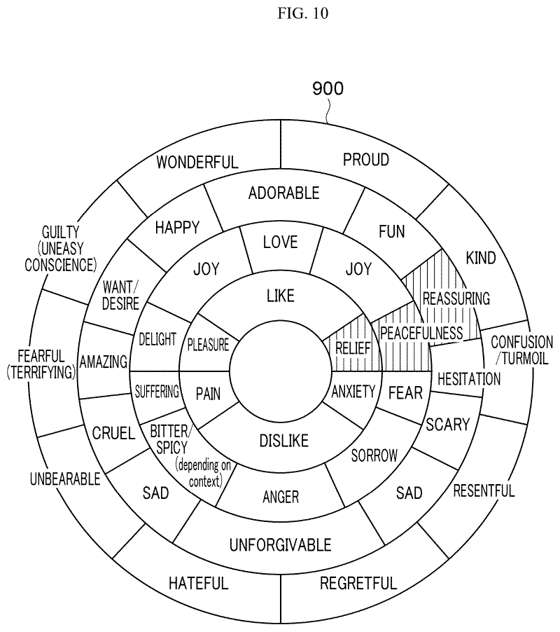

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
obtain identification information and authentication information from a terminal that includes an input and output device for receiving information from a user,
receive, via a communication scheme, the identification information and the authentication information transmitted from the terminal, collate an information set stored in a storage device based on the identification information and the authentication information, and extract user information including usage state information and unsubscribed service information, generate a query sentence based on the extracted user information in order to automatically specify the unsubscribed service information, and input the query sentence to a generative processing model so as to obtain additional service information related to the unsubscribed service information,
convert the user information and the additional service information into a structured data format, and transmit the information in the structured data format to the terminal via an encrypted communication scheme,
cause the terminal to analyze the transmitted information in the structured data format and present the usage state information, the unsubscribed service information, and the additional service information in a visually recognizable manner on a display device,
analyze voice information of the user at the terminal or at a server device, evaluate an emotional state of the user, and adjust a display order or a notification order of the unsubscribed service information and the additional service information based on the emotional state, and
use natural language processing technology to generate a prompt sentence to be input to the generative processing model, the prompt sentence being automatically generated from contents of the received information so as to generate the query sentence, and reflect a generation result corresponding to the prompt sentence as the additional service information in classification of the information.

### Supplementary 2

The system according to supplementary 1,
wherein the processor is configured to
generate an inquiry processing instruction to an information management mechanism that manages the information set stored in the storage device, execute an inquiry processing using the identification information and the authentication information as search conditions so as to obtain the user information including the usage state information and the unsubscribed service information, and execute a data conversion processing for converting the obtained user information into the structured data format.

### Supplementary 3

The system according to supplementary 1,
wherein the processor is configured to
calculate an emotion index based on feature quantities extracted from the voice information of the user, execute a priority setting processing that determines priorities for the unsubscribed service information and the additional service information in accordance with the emotion index, and control a presentation order and a presentation mode to the terminal based on the priorities.

### Application Example 1

### Supplementary 1

A system comprising a processor,
wherein the processor is configured to
receive, via a communication interface, structured data including personal identification information from an information processing apparatus operated by a user over a wireless communication line; and
extract the personal identification information from the structured data, access an information storage unit that manages usage history information in a storage device based on the personal identification information, acquire the usage history information, aggregate, by arithmetic processing, usage period information, usage status information, and unsubscribed service information included in the usage history information, and generate customer attribute information including the usage period information, the usage status information, and the unsubscribed service information; and
convert the customer attribute information into a natural language expression, and generate a prompt sentence that instructs a generative AI model to generate personalized proposal content and optimal talk for face-to-face interaction based on the customer attribute information; and
input the generated prompt sentence into the generative AI model, acquire natural language text output from the generative AI model, extract at least a short notification message and detailed proposal content from the natural language text, and generate service proposal information to be provided to the user based on the extracted proposal content; and
transmit the service proposal information as structured data toward the information processing apparatus, and control so that the short notification message and the detailed proposal content are displayable on the information processing apparatus; and
analyze voice data of the user to evaluate an emotional state of the user, and execute a priority setting algorithm that changes a presentation order or importance of the service proposal information based on a result of the evaluation.

### Supplementary 2

The system according to supplementary 1,
wherein the processor is configured to
use natural language processing technology to construct the prompt sentence, by automatically generating a description including the usage period information, the usage status information, and the unsubscribed service information contained in the customer attribute information, and input the prompt sentence into the generative AI model to obtain, from the generative AI model, analysis results including personalized service proposal information and the optimal talk.

### Supplementary 3

The system according to supplementary 1,
wherein the processor is configured to
extract emotional feature values from the voice data of the user, numerically calculate a display priority for each proposal item included in the service proposal information according to the emotional feature values, and dynamically change the presentation order within the service proposal information to be transmitted to the information processing apparatus based on the display priority.

### Example 2

### Supplementary 1

A system comprising a processor,
wherein the processor is configured to
receive individual identification information from a user via an interface,
acquire, based on the individual identification information, usage history information including usage period information, usage status information, and non-contracted service information from a record information storage device,
analyze the acquired usage history information by executing tabular data processing in an information processing program execution environment so as to extract, for each individual, usage frequency information, usage tendency information, and candidate non-contracted service information,
generate a prompt sentence instructing generation of proposal content for the individual, based on the extracted usage frequency information, usage tendency information, and candidate non-contracted service information,
input the generated prompt sentence to a generative information processing model and acquire, from the generative information processing model, analysis result information including proposal content optimized for each individual,
convert the acquired analysis result information into a structured data format and transmit the structured data via a communication network to a terminal so that the terminal displays the proposal content,
receive information from the user via the interface, generate a prompt sentence that instructs the generative information processing model to classify the information into related services, input the prompt sentence to the generative information processing model, acquire an analysis result from the generative information processing model, and classify the information into services based on the analysis result, and
analyze voice information of the user to evaluate emotional state information and adjust priority information of the information and the proposal content based on the emotional state information.

### Supplementary 2

The system according to supplementary 1,
wherein the processor is configured to
analyze received information and acquired usage history information by using a natural language processing technique, automatically generate, based on a result of the analysis, the prompt sentence including an instruction to identify related services and proposal content suitable for the individual, and input the prompt sentence to the generative information processing model to perform analysis.

### Supplementary 3

The system according to supplementary 1,
wherein the processor is configured to
execute a priority setting algorithm that takes, as input, the voice information of the user, the usage status information, and information relating to the proposal content, and that changes an output order or a presentation degree of the information and the proposal content based on the emotional state information and the usage tendency information, and automatically control priorities of service classification results and proposal content displayed on the terminal according to the priority setting algorithm.

### Application Example 2

### Supplementary 1

A system comprising a processor,
wherein the processor is configured to
receive, via an interface for receiving information from a user, identification information and inquiry information,
search a user information storage region in a storage device based on the received identification information and acquire user attribute information including a usage period, a usage status, and unsubscribed items,
generate a prompt sentence, based on the acquired user attribute information and the inquiry information, for causing a generative information processing apparatus to specify a related processing target,
input the generated prompt sentence to the generative information processing apparatus and, based on a natural language analysis result obtained from the generative information processing apparatus, automatically classify the inquiry information into the related processing target,
input voice data, acquired from a voice acquisition device, to a speech recognition processing apparatus and an emotion analysis processing apparatus, estimate an emotional state, and set a priority of the inquiry information and the classification result based on the estimated emotional state,
generate, based on the user attribute information and the emotional state, a prompt sentence for instructing the generative information processing apparatus to generate proposal content or a dialogue script, and generate guidance information to be presented to the user or to a respondent based on proposal content or a dialogue script obtained from the generative information processing apparatus, and
output the guidance information in real time via a visual display device and/or an audio output device.

### Supplementary 2

The system according to supplementary 1,
wherein the processor is configured to
perform natural language processing on text data including the received inquiry information and the acquired user attribute information, and dynamically generate a plurality of types of prompt sentences in which instruction content and output formats are defined so that the generative information processing apparatus generates the related processing target, the proposal content, and the dialogue script with high accuracy.

### Supplementary 3

The system according to supplementary 1,
wherein the processor is configured to
execute a priority setting algorithm that determines a processing order of the information and a response mode, using as input the emotional state and a confidence degree thereof estimated by the emotion analysis processing apparatus, the user attribute information, and the classification result, and to further include the emotional state in the prompt sentence so as to automatically adjust an expression style of the proposal content or the dialogue script obtained from the generative information processing apparatus in accordance with the emotional state.

What is claimed is:

1. A system comprising:
circuitry configured to:
receive, via a communication interface coupled to a packet-switched network, identification information and authentication information transmitted from a terminal device;
collate an information set stored in a storage device based on the identification information and the authentication information to extract user information comprising usage state information and unsubscribed item information;
generate a query sentence based on the extracted user information, and input the query sentence to a generative neural network model to obtain additional item information related to the unsubscribed item information;
generate a prompt sentence using a natural language processing function, the prompt sentence being automatically generated from contents of the received information to instruct the generative neural network model to identify a relevant service category for the user information based on an analysis of the user information;
input the prompt sentence to the generative neural network model, obtain an analysis result, and classify the user information into a service category based on the analysis result;
convert the user information and the additional item information into a structured data format and transmit the structured data format to the terminal device via the communication interface; and
analyze voice information received from the terminal device to evaluate an emotional state of the user, and adjust a display order or a notification order of the unsubscribed item information and the additional item information based on the evaluated emotional state.

2. The system according to claim 1, wherein the circuitry is configured to collate the information set by performing a lookup in the storage device using the identification information as a key, retrieving records associated with the identification information, and verifying the authentication information against a credential stored in the storage device prior to extracting the user information.

3. The system according to claim 2, wherein the circuitry is configured to extract the usage state information comprising at least a subscription status, a usage frequency indicator, and a last interaction timestamp, and to extract the unsubscribed item information comprising identifiers of service categories not currently associated with the identification information.

4. The system according to claim 3, wherein the circuitry is configured to generate the query sentence by encoding the unsubscribed item information and the usage state information into a structured text representation, and to input the query sentence to the generative neural network model to obtain additional item information comprising related service categories and associated attribute data.

5. The system according to claim 4, wherein the circuitry is configured to generate the prompt sentence by applying a natural language processing function to the user information to extract at least an intent indicator and a context indicator, and to construct the prompt sentence by combining the intent indicator, the context indicator, and a service classification instruction as a structured input sequence for the generative neural network model.

6. The system according to claim 1, wherein the circuitry is configured to classify the user information into the service category by parsing the analysis result from the generative neural network model to extract a service category label and an associated confidence score, and to assign the user information to the service category corresponding to the highest confidence score.

7. The system according to claim 6, wherein the circuitry is configured to execute a classification refinement process when a confidence score of the service category fails to satisfy a threshold by generating a revised prompt sentence incorporating additional contextual information from the user information, and re-inputting the revised prompt sentence to the generative neural network model.

8. The system according to claim 1, wherein the circuitry is configured to convert the user information and the additional item information into the structured data format by serializing the information into a machine-parsable schema, and to transmit the structured data format to the terminal device via an encrypted communication session established over the communication interface.

9. The system according to claim 1, wherein the circuitry is configured to analyze the voice information by extracting acoustic features from the voice information, applying an emotion classification model to the extracted acoustic features to classify the emotional state into an emotional category, and computing an urgency indicator based on the classified emotional category.

10. The system according to claim 9, wherein the circuitry is configured to adjust the display order or the notification order by applying a priority ordering algorithm to the unsubscribed item information and the additional item information, the priority ordering algorithm assigning higher ordering priority to items associated with the emotional category of the evaluated emotional state.

11. The system according to claim 10, wherein the circuitry is configured to execute the priority ordering algorithm by mapping each emotional category to a reordering weight, multiplying a base relevance score of each item by the reordering weight corresponding to the evaluated emotional state, and sorting items in descending order of the resulting weighted score.

12. The system according to claim 1, wherein the circuitry is configured to generate the prompt sentence to include a multi-intent analysis instruction that causes the generative neural network model to identify a plurality of service categories relevant to the user information and to assign a relevance score to each identified service category, and to transmit service category information comprising the plurality of service categories ordered by relevance score to the terminal device.

13. The system according to claim 1, wherein the circuitry is configured to receive mixed input data comprising at least one of text data and voice data from the terminal device, apply the natural language processing function to the text data and the emotion classification model to the voice data, and integrate analysis results from both modalities to generate the prompt sentence.

14. The system according to claim 13, wherein the circuitry is configured to weight analysis results from the voice data and the text data based on a signal quality indicator associated with each modality, and to adjust the prompt sentence based on the weighted analysis results to improve classification accuracy of the generative neural network model.

15. The system according to claim 1, wherein the circuitry is configured to store a classification history comprising prior service category assignments and associated user information in the storage device, and to incorporate a summarized representation of the classification history into the prompt sentence to improve consistency of service category classification for the user.

16. The system according to claim 15, wherein the circuitry is configured to detect a change in the usage state information relative to the classification history, and to generate an updated prompt sentence incorporating the detected change to cause the generative neural network model to revise a prior service category assignment for the user information.

17. The system according to claim 1, wherein the circuitry is configured to generate a notification based on the additional item information obtained from the generative neural network model, and to transmit the notification to the terminal device via the communication interface according to a notification timing determined based on the evaluated emotional state.

18. A system comprising:
circuitry configured to:
receive, via a communication interface coupled to a packet-switched network, identification information and authentication information from a terminal device;
verify the authentication information against a credential stored in a storage device, extract user information comprising usage state information and unsubscribed item information from the storage device based on the identification information;
generate a query sentence encoding the unsubscribed item information and the usage state information, input the query sentence to a generative neural network model to obtain additional item information, and apply a natural language processing function to the user information to generate a prompt sentence comprising an intent indicator and a service classification instruction;
input the prompt sentence to the generative neural network model, obtain an analysis result comprising a service category label and a confidence score, and classify the user information into a service category based on the confidence score;
convert the user information and the additional item information into a structured data format and transmit the structured data format to the terminal device via an encrypted communication session; and
extract acoustic features from voice information received from the terminal device, apply an emotion classification model to classify an emotional state, compute an urgency indicator, and adjust a display order or a notification order of the unsubscribed item information and the additional item information based on the classified emotional state.

19. The system according to claim 18, wherein the circuitry is configured to execute a priority ordering algorithm that maps the classified emotional state to a reordering weight, multiplies a base relevance score of each item by the reordering weight, and sorts items in descending order of the resulting weighted score to generate an ordered presentation of the unsubscribed item information and the additional item information.

20. A method comprising:
receiving, via a communication interface coupled to a packet-switched network, identification information and authentication information transmitted from a terminal device;
collating an information set stored in a storage device based on the identification information and the authentication information to extract user information comprising usage state information and unsubscribed item information;
generating a query sentence based on the extracted user information, and inputting the query sentence to a generative neural network model to obtain additional item information related to the unsubscribed item information;
generating a prompt sentence using a natural language processing function, the prompt sentence being automatically generated from contents of the received information to instruct the generative neural network model to identify a relevant service category for the user information based on an analysis of the user information;
inputting the prompt sentence to the generative neural network model, obtaining an analysis result, and classifying the user information into a service category based on the analysis result;
converting the user information and the additional item information into a structured data format and transmitting the structured data format to the terminal device via the communication interface; and
analyzing voice information received from the terminal device to evaluate an emotional state of the user, and adjusting a display order or a notification order of the unsubscribed item information and the additional item information based on the evaluated emotional state.
